(19) United States
(12) Patent Application Publication
(10) Pub. No.: US 2024/0045928 A1
(43) Pub. Date: Feb. 8, 2024

(54) CLUSTER-BASED MACHINE LEARNING MODEL VALIDATION

(71) Applicant: McAfee, LLC, San Jose, CA (US)

(72) Inventor: Daniel L. Burke, Beaverton, OR (US)

(73) Assignee: McAfee, LLC, San Jose, CA (US)

(21) Appl. No.: 17/881,215

(22) Filed: Aug. 4, 2022

(51) Int. Cl. G06K 9/62; G06N 20/00

(52) U.S. Cl. CPC G06K 9/6262; G06K 9/6201; G06K 9/6272; G06K 9/628; G06N 20/00

(57) ABSTRACT

There is disclosed a method and system therefor, the method for validating a machine learning (ML) model, wherein the ML model is a binary classifier, the method including training the ML model on a training set comprising labeled objects from a first class and a second class; and validating the ML model on a training set, wherein the training set comprises at least some unlabeled objects, and for unlabeled objects, using an estimated classification as a proxy for a known label, wherein the estimated classification is based on computing a smallest distance to respective known feature vector clusters for the first and second classes.

### FIELD OF THE SPECIFICATION

The present specification relates to the field of machine learning, and more particularly though not exclusively to a system and method for providing cluster-based machine learning model validation.

### BACKGROUND

One of the most persistent problem spaces in the computer security arts is the identification of malicious files, objects, and/or scripts.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram of selected elements of a security ecosystem.

FIG. 2 is a block diagram of selected elements of a malware detection ecosystem.

FIG. 3 is a flowchart of selected elements of a method of generating clusters.

FIG. 4 is a flowchart of selected elements of a method of generating minimum cluster distance scores.

FIG. 5 is a flowchart of selected elements of a method of generating a distance array.

FIGS. 6A and 6B provide a flowchart of selected elements of a method of validating a model using generated clusters.

FIG. 7 is an illustration of selected elements of a validation graph.

FIG. 8 is a block diagram of selected elements of a hardware platform.

FIG. 9 is a block diagram of selected elements of a network function virtualization (NFV) infrastructure.

FIG. 10 is a block diagram of selected elements of a containerization infrastructure.

FIG. 11 illustrates selected elements of machine learning according to a “textbook” problem with real-world applications.

FIG. 12 is a flowchart of selected elements of a method that may be used to train a neural network.

FIG. 13 is a flowchart of selected elements of a method of using a neural network to classify an object.

FIG. 14 is a block diagram illustrating selected elements of an analyzer engine.

### SUMMARY

There is disclosed a method and system therefor, the method for validating a machine learning (ML) model, wherein the ML model is a binary classifier, the method including training the ML model on a training set comprising labeled objects from a first class and a second class; and validating the ML model on a training set, wherein the training set comprises at least some unlabeled objects, and for unlabeled objects, using an estimated classification as a proxy for a known label, wherein the estimated classification is based on computing a smallest distance to respective known feature vector clusters for the first and second classes.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

### Overview

One of the fundamental expectations of a security services vendor, such as McAfee, Inc., is that the vendor will provide software that can differentiate between malicious objects and clean or benign objects. Such software may be designated a binary classifier, meaning that the software will scan an object and designate the object as one of two classes, such as clean or malicious. Other designations are also used, such as malware versus clean (also known as “safe,” “benign”) potentially unwanted programs versus wanted programs, or other designations.

Earlier generations of such software focused on scanning portable executable (PE) files using hashes to compare them to known malware files. As malware has become more sophisticated, this type of scanning may be overly naïve to address modern malware threats. Modern malware comes in many different forms, such as PEs, shared object libraries, dynamic link libraries, shell scripts, command line parameters, parameter hijacking, scheduled tasks, living off the land attacks, and others. Furthermore, modern malware may use sophisticated means to obscure its identity and make it harder to detect. Another challenge is that modern malware is often created with a generator that makes each release different, so the hashes will not match.

Thus, a modern malware binary classifier may require more sophisticated techniques, and in some embodiments, may include an artificial intelligence (AI) engine that scans various types of objects and classifies them according to a binary classifier. This classification may be done with a particular confidence. For example, a Machine Learning (ML) based classifier may first apply feature extraction, which generates an array or vector of feature values for a sample. The matrix of labeled vectors may be used to train a model. This model can then evaluate the vectors of unknown samples to assign them a classification. Various models can use different approaches. For example, a cluster-based model may operate on feature similarity. Other models may use algorithms that are not based on feature or file similarity, such as tree-based models, logistic regression models, or neural net models. Any of these models (or other ML models) may be validated against a validator, which may evaluate model performance using cluster-based similarity to compare results of one model to results of a different model.

In an example, an AI-based scanner may scan an object and determine with theoretically perfect certainty that the object is malware. In that case, the AI scanner may assign a confidence of 1.0 that the object is malware. Conversely, the scanner may scan an object and determine with theoretically perfect confidence that the object is benign. In that case, the scanner may assign the object a reputation of clean with a confidence of 1.0. In scanning other objects, the binary classifier may assign the objects a reputation as clean or malicious with a respective confidence for each class between 0.0 and 1.0, to any suitable resolution or number of decimal places supported by the system. If the AI scanner scans an object and the weightings for malware are, with theoretically perfect certainty, equal to the weightings for clean, then the binary classifier may assign a confidence of 0.0, meaning that it is equally likely that the object is malware or clean. This essentially results in no meaningful classification; the object is simply unknown.

In some examples, a confidence may be calculated based on an absolute difference between two objects. The absolute difference may be an absolute value of the difference between the two scores.

A common method for an AI to analyze any object is to break the object down into a number of features. Features represent any measurable property or characteristic of the object being analyzed. The AI may identify features in the object, assign weights to the various features representing how important those features are to the identification, and then assign a feature vector to the object. The AI engine can then compare this feature vector to feature vectors of similar objects to classify the object according to the similarity of its features as compared to other known or previously labeled objects.

While it is theoretically possible to design an AI model in which the features are explicitly designated manually by acumen and assign the corresponding weights, in most real-world AI applications, such manual design would be impractical. Thus, a popular approach is to use Machine Learning to assign the weights or create the decision trees automatically. A popular subset of ML is a deep learning (DL) network, in which higher order features are discovered automatically from the base features, usually through a neural network. DL is provided here as an illustrative example of a species of AI that may benefit from the validator described herein. Other species of AI may also equally benefit from the validator (e.g., tree-based models, logistic regression, or a rules machine).

In an illustrative example of a DL neural network, an AI is provided with multiple layers of “neurons” that will initially receive objects from a training set. The training set may include objects that have previously been classified, such as by another trusted ML model, or by human classification. These objects may be fed to the untrained AI, and the untrained AI may classify the objects according to its existing connections, feature maps, and weights. Initially, with a completely untrained AI, the assignments may be essentially random and useless. However, part of the training process is to then provide the AI with feedback, including information about the correct classification of the object, which was previously known. The ML model can then use back-propagation to iteratively correct its features and weights and improve the AI model. As more and more training objects are provided to the ML model and as feedback is back-propagated, the ML model generally becomes better trained and more accurate. After a certain level of training, the ML model may be designated as trained and may be ready for the next phase of its use, which is often a validation phase.

In a validation phase, the ML model is provided with a large number of validation data, which may be different from the training data. In common practice, the validation data may also have known labels so that the results of ML model classifier can be compared to the known labels. If the ML model has a very high detection rate with a very low false positive rate, then the model may be deemed valid and may then be prepared for live staging.

Binary classification of malware and clean objects is used in this specification as an illustrative example of the teachings. This example should be understood to be nonlimiting. The teachings of this specification are applicable to any ML model that performs binary classification. In practice, when a model has been sufficiently trained and optionally verified, it may be released in silent mode or active mode. In silent mode, the ML model may run in its intended environment but may have no or limited ability to actively affect the environment. In other words, the binary classifier may run in its intended environment, may encounter objects, and may classify those objects, but until the model is trusted, it is not permitted to act on those classifications. Thus, silent mode may be considered a validation phase or an additional validation phase.

In active mode, the ML model may already be sufficiently trusted (e.g., it has already been sufficiently validated) that it can actively perform its function, such as by identifying malicious objects and taking appropriate remedial action such as quarantining the objects, notifying security administrators, scrubbing the objects, or performing some other malware-based action.

In the concrete example of a security services vendor, a new ML model may be pushed out as an update to a security services suite. The model may run on a protected enterprise and may monitor the network and individual endpoints of that enterprise. As the ML model encounters new objects on the enterprise network, it may classify those objects and, depending on its mode, take appropriate action. One challenge in such an enterprise deployment is that the ML model may encounter a large number of unlabeled objects that may be unique to the enterprise. For example, if the enterprise performs software development, the ML model may encounter a large number of PE files that are unknown to it, and that may be very different from those encountered in the training set. Similarly, users may generate documents with macros, IT services may push out enterprise scripts that perform actions appropriate to the enterprise, or other enterprise activities may generate data that are new to the ML model. Furthermore, some of these objects may exhibit static features or behavior that superficially appear similar to malware. For example, an enterprise configuration script may use certain command line parameters, subroutines, or other objects that modify protected areas of an operating system. In the wild, this may appear as malware features, but in the enterprise context, it may be completely legitimate. That enterprise context may itself be a feature that the ML model can consider, and a well-trained ML model may be able to differentiate legitimate enterprise configuration scripts from malware. However, in the enterprise context where a large number of unlabeled objects are encountered, validation can be a difficulty.

When a new model is released in silent mode or active mode, it may process many unlabeled files in the field. Existing methods may be known for measuring the detection effectiveness of a model using labeled samples. But once the model is released, to get a valid measure of how the model performs for customers, it may be desirable to know how accurate the model's classifications are with respect to files that it encounters on the individual customers' environment. One known approach can be to examine hashes of files in countered by the model in the field and then take a subset of those that have known classifications and statistically judge the model on that basis. This may include extrapolating to the total number of files encountered. A downside of this approach is that the known samples may not be representative of the total set of samples.

For example, the known samples may be samples that the model has been trained or tested on. New malware objects may not yet be classified and so may not show up in this set. Furthermore, new clean files may be frequently created within the enterprise, and many of those will be absent from the known files database. As a workaround, many ML models are run in silent mode for a few months after being released and are then judged on the basis of files that have been classified for the previous months during the silent mode operation. Ideally, there will be enough files that were new to the model, and that now have known classifications, which can be used to validate the model or judge its detection effectiveness.

A disadvantage of this approach is that it limits the speed of new model activation, and it may miss spikes of incorrect classifications of malware or clean files that were missing from the known labeled databases. This may be especially likely with new clean files that trigger false positives and are unlikely to be in a known file database. This may include, for example, files that are unique to the particular enterprise or environment, like IT-generated scripts or log files. The present specification provides an improved ML validator with an associated apparatus and method. This validator may be used to judge the performance of a model using features extracted from unlabeled samples in the field. Evaluations are often limited to features extracted because the security services vendor may not have access to the unlabeled samples. Exporting full unlabeled samples can raise both data privacy and bandwidth concerns. So the feature vectors may be used to compute clustered feature similarity (versus analysis of whole files or raw bytes). This example does not, however preclude the use of full features in cases where full files are available, and it is practical to export them.

Separate sets of clusters for clean and malware files may then be generated based on features extracted by a malware classifier. These clusters can be used to determine the similarity of new files to known labeled clusters with a confidence level based on cluster similarity. Unlabeled field data can be used to validate the model by comparing the model classifications to see if they fall within the expected range for the files based on the classifier model, adjusted for error bars that are the inverse of the confidence level.

This method may be used to train both a clean and malware set of clusters on labeled data for the purpose of judging unlabeled samples based on the minimum distance between any cluster in each set. This specification also provides a method of building clusters used in this process. In some embodiments, custom distance metrics may be used to judge similarity to a cluster core. The determination of confidence level of the validator's assessment of its classification of a sample may be based on the cluster set distance separability.

Advantageously, this method can speed up activation of a model as unlabeled field data can be used in validation. Thus, the model can be activated sooner rather than waiting for additional samples to receive known classifications. Furthermore, this system can immediately identify likely issues and probable false positive or false negative spikes in a model on new field data that should be looked into before the activation is considered.

These benefits are achieved by clustering feature vectors of known malware and clean samples. Objects under analysis can then be reduced to a set of feature vectors that can be compared to these known clusters, and a custom distance may be computed between the unknown object and the nearest known malware and nearest known clean feature vector cluster. If the unknown object has a much shorter distance to a known malware feature vector cluster, then the validator may determine with high confidence that the unknown sample is malware. Conversely, if the object under analysis has a feature vector with a distance much shorter to a known clean feature vector cluster, then the validator may determine with high confidence that the object is clean. On the other hand, if the object is roughly equidistant from known malware feature vector clusters and known clean feature vector clusters, then the validator may not be able to assign the object a class with high confidence.

Notably, the classification provided by the validator fro specific samples may optionally be less dependable and less reliable than the actual classification provided by the ML model. The classification provided by the validator may instead be essentially a rough guess of which class the object belongs to.

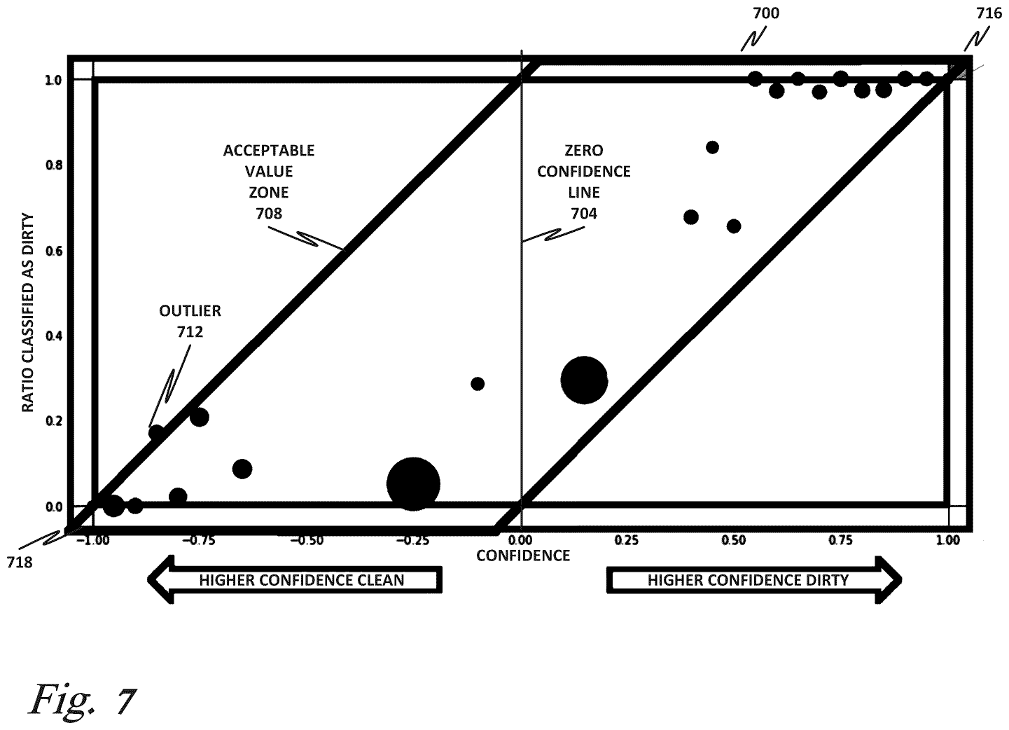

In other cases, (as with the model validation chart illustrated in FIG. 7 below), all of the data may be used to ensure they falls within the error bars (although the relatively rare data that fall around zero confidence have no impact on the score). In that, the sum of the outliers becomes the final model validation score.

In many cases, the validator may not be able to make a high confidence prediction of which class the object under analysis belongs to. In those cases, the validator classification may be of limited usefulness in validation. But in cases where the validator can make a relatively high confidence estimate of the proper class for the object, that estimated classification can be used as a proxy for a known label for validation purposes. In various environments, a “relatively high confidence estimate” is determined by a confidence threshold, and different confidence thresholds may be used in different embodiments. For example, validators may use a confidence threshold over 0.3, 0.4, 0.5, 0.6, 0.7, 0.8 and/or 0.9. Selecting an appropriate confidence threshold may depend on the engineering constraints of a particular deployment.

In cases where the validator is able to estimate the correct classification with sufficient confidence, the validator may use the estimated classification as a proxy for a label for the unknown object. This can then be used to compare to the classification provided by the full ML model and can provide a useful validation. Even in cases where only a relatively small subset of objects can provide a high confidence estimated classification (e.g., even if only 25 or 30 percent of objects can be confidently estimated), with a sufficiently large training set of both labeled and unlabeled objects, the validator can still provide a high confidence validation of the overall ML model.

This method provides for the use of unlabeled data in validation of a model with the confidence level of each sample being used to ensure the expected value ranges. A resulting graph output from the system may point to outlier ranges that can be found in the data by confidence level and isolated for further examination and/or validation.

### SELECTED EXAMPLES

The foregoing can be used to build or embody several example implementations, according to the teachings of the present specification. Some example implementations are included here as nonlimiting illustrations of these teachings.

Example 1 is computer-implemented method of validating a machine learning (ML) model, wherein the ML model is a binary classifier, the method comprising: training the ML model on a training set comprising labeled objects from a first class and a second class, to provide a trained ML model; and validating the ML model on a training set, wherein the training set comprises at least some unlabeled objects, and for unlabeled objects, using an estimated classification as a proxy for a known label, wherein the estimated classification is based on computing a smallest distance to respective known feature vector clusters for the first and second classes.

Example 2 is the method of example 1, wherein the binary classifier is a malware classifier, and wherein the first class is a clean class the second class is a malware class.

Example 3 is the method of example 1, further comprising assigning a confidence to the estimated classification.

Example 4 is the method of example 3, wherein the confidence comprises an absolute difference between a distance to a nearest feature vector cluster for the first class and a distance to a nearest feature vector cluster for the second class.

Example 5 is the method of example 3, further comprising assigning the unlabeled objects to confidence buckets based on the respective confidences of the unlabeled objects.

Example 6 is the method of example 5, further comprising computing error bars for the confidence buckets.

Example 7 is the method of example 6, further comprising identifying an outlier cluster of feature vectors outside of the error bars, and designating the outlier cluster for additional analysis.

Example 8 is the method of example 5, further comprising aggregating counts of the first class and second class by confidence bucket.

Example 9 is the method of example 8, further comprising calculating an error for the confidence bucket using an average prediction score and total count of feature vectors.

Example 10 is the method of example 3, further comprising determining that the confidence is below a threshold for an unlabeled object, and excluding the unlabeled object from validation.

Example 11 is the method of example 1, further comprising computing the respective known feature vector clusters.

Example 12 is the method of example 11, wherein computing the known feature vector clusters comprises receiving a set of feature vectors for known objects, including objects of the first class and objects of the second class, and computing for respective known feature vectors a smallest minimum distance to a cluster core.

Example 13 is the method of example 12, wherein computing the smallest minimum distance comprises generating a distance score array, calculating a sum of closest distances for individual feature vectors, and adding the sum to the distance score array.

Example 14 is the method of example 13, wherein generating the distance score array comprises creating a zeroed array of distances with indexes matching an array of feature vectors, and for each of a set of input feature vectors, computing a distance between the input feature vector and an iterated feature vector.

Example 15 is the method of example 1, wherein computing the smallest distance to respective known feature vector clusters comprises computing a first distance to a nearest cluster core of the first class and second distance to a nearest cluster core of the second class, and selecting an estimated class based on a lesser of the first distance or the second distance.

Example 16 is the method of any of examples 1-15, further comprising computing a model score for the ML model as disproportional to a ratio of total error amount to total number of model classifications.

Example 17 is the method of any of examples 1-16, further comprising computing distances according to a Jaccard B function.

Example 18 is an apparatus comprising means for performing the method of any of examples 1-17.

Example 19 is the apparatus of example 18, wherein the means for performing the method comprise a processor and a memory.

Example 20 is the apparatus of example 19, wherein the memory comprises machine-readable instructions that, when executed, cause the apparatus to perform the method of any of examples 1-17.

Example 21 is the apparatus of any of examples 18-20, wherein the apparatus is a computing system.

Example 22 is at least one computer readable medium comprising instructions that, when executed, implement a method or realize an apparatus as described in any of examples 1-21.

Example 23 is one or more tangible, nontransitory computer-readable media having stored thereon machine-executable instructions to validate a trained machine learning (ML) model, wherein the ML model is a binary classifier, and wherein validating the ML model comprises receiving a training set, the training set comprising objects including both labeled objects and unlabeled objects, operating the ML model to classify the objects of the training set as belonging to a first class or a second class, for labeled objects, comparing the classification to a known class of the labeled objects, and for unlabeled objects, comparing the classification to an estimated label, comprising estimating labels for at least some of the unlabeled objects, wherein estimating the labels comprises extracting a feature vector for an object, and calculating a distance from the extracted feature vector to feature vector clusters for the first class and second class.

Example 24 is the one or more tangible, nontransitory computer-readable media of example 23, wherein the binary classifier is a malware classifier, and wherein the first class is a clean class the second class is a malware class.

Example 25 is the one or more tangible, nontransitory computer-readable media of example 23, wherein the instructions are further to assig a confidence to the estimated labels.

Example 26 is the one or more tangible, nontransitory computer-readable media of example 25, wherein the confidence comprises an absolute difference between a distance to a nearest feature vector cluster for the first class and a distance to a nearest feature vector cluster for the second class.

Example 27 is the one or more tangible, nontransitory computer-readable media of example 25, wherein the instructions are further to assign the unlabeled objects to confidence buckets based on the respective confidences of the unlabeled objects.

Example 28 is the one or more tangible, nontransitory computer-readable media of example 27, wherein the instructions are further to compute error bars for the confidence buckets.

Example 29 is the one or more tangible, nontransitory computer-readable media of example 28, wherein the instructions are further to identify an outlier cluster of feature vectors outside of the error bars, and designate the outlier cluster for additional analysis.

Example 30 is the one or more tangible, nontransitory computer-readable media of example 27, wherein the instructions are further to aggregate counts of the first class and second class by confidence bucket.

Example 31 is the one or more tangible, nontransitory computer-readable media of example 30, wherein the instructions are further to calculate an error for the confidence bucket using an average prediction score and total count of feature vectors.

Example 32 is the one or more tangible, nontransitory computer-readable media of example 25, wherein the instructions are further to determine that the confidence is below a threshold for an unlabeled object, and excluding the unlabeled object from validation.

Example 33 is the one or more tangible, nontransitory computer-readable media of example 23, wherein the instructions are further to compute the feature vector clusters.

Example 34 is the one or more tangible, nontransitory computer-readable media of example 33, wherein computing the feature vector clusters comprises receiving a set of feature vectors for known objects, including objects of the first class and objects of the second class, and computing for respective known feature vectors a smallest minimum distance to a cluster core.

Example 35 is the one or more tangible, nontransitory computer-readable media of example 34, wherein computing the smallest minimum distance comprises generating a distance score array, calculating a sum of closest distances for individual feature vectors, and adding the sum to the distance score array.

Example 36 is the one or more tangible, nontransitory computer-readable media of example 35, wherein generating the distance score array comprises creating a zeroed array of distances with indexes matching an array of feature vectors, and for each of a set of input feature vectors, computing a distance between the input feature vector and an iterated feature vector.

Example 37 is the one or more tangible, nontransitory computer-readable media of example 23, wherein computing the distance to the feature vector clusters comprises computing a first distance to a nearest cluster core of the first class and second distance to a nearest cluster core of the second class, and selecting an estimated class based on a lesser of the first distance or the second distance.

Example 38 is the one or more tangible, nontransitory computer-readable media of any of examples 23-37, wherein the instructions are further to compute a model score for the ML model as disproportional to a ratio of total error amount to total number of model classifications.

Example 39 is the one or more tangible, nontransitory computer-readable media of example 38, further comprising plotting a model validation for the model, and presenting the plot to a human user.

Example 40. is a computing apparatus, comprising: a processor circuit and a memory; and instructions encoded within the memory to instruct the processor circuit to validate a trained machine learning (ML) model, wherein the ML model is a binary classifier to classify objects into a first class and a second class, and wherein validating the ML model comprises: receiving a training set, the training set comprising objects including both labeled objects and unlabeled objects; operating the ML model to classify the objects of the training set; for labeled objects, comparing the classification to a known class of the labeled objects; for unlabeled objects, estimating labels, comprising extracting a feature vector for an object, calculating a distance from the extracted feature vector to feature vector clusters for the first class and second class, and comparing the classification to the estimated label.

Example 41 is the computing apparatus of example 40, wherein the binary classifier is a malware classifier, and wherein the first class is a clean class the second class is a malware class.

Example 42 is the computing apparatus of example 40, wherein the instructions are further to assig a confidence to the estimated labels.

Example 43 is the computing apparatus of example 42, wherein the confidence comprises an absolute difference between a distance to a nearest feature vector cluster for the first class and a distance to a nearest feature vector cluster for the second class.

Example 44 is the computing apparatus of example 42, wherein the instructions are further to assign the unlabeled objects to confidence buckets based on the respective confidences of the unlabeled objects.

Example 45 is the computing apparatus of example 44, wherein the instructions are further to compute error bars for the confidence buckets.

Example 46 is the computing apparatus of example 45, wherein the instructions are further to identify an outlier cluster of feature vectors outside of the error bars, and designate the outlier cluster for additional analysis.

Example 47 is the computing apparatus of example 44, wherein the instructions are further to aggregate counts of the first class and second class by confidence bucket.

Example 48 is the computing apparatus of example 47, wherein the instructions are further to calculate an error for the confidence bucket using an average prediction score and total count of feature vectors.

Example 49 is the computing apparatus of example 42, wherein the instructions are further to determine that the confidence is below a threshold for an unlabeled object, and excluding the unlabeled object from validation.

Example 50 is the computing apparatus of example 40, wherein the instructions are further to compute the feature vector clusters.

Example 51 is the computing apparatus of example 50, wherein computing the feature vector clusters comprises receiving a set of feature vectors for known objects, including objects of the first class and objects of the second class, and computing for respective known feature vectors a smallest minimum distance to a cluster core.

Example 52 is the computing apparatus of example 51, wherein computing the smallest minimum distance comprises generating a distance score array, calculating a sum of closest distances for individual feature vectors, and adding the sum to the distance score array.

Example 53 is the computing apparatus of example 52, wherein generating the distance score array comprises creating a zeroed array of distances with indexes matching an array of feature vectors, and for each of a set of input feature vectors, computing a distance between the input feature vector and an iterated feature vector.

Example 54 is the computing apparatus of example 40, wherein computing the distance to the feature vector clusters comprises computing a first distance to a nearest cluster core of the first class and second distance to a nearest cluster core of the second class, and selecting an estimated class based on a lesser of the first distance or the second distance.

Example 55 is the computing apparatus of any of examples 40-54, wherein the instructions are further to compute a model score for the ML model as disproportional to a ratio of total error amount to total number of model classifications.

Example 56 is the computing apparatus of example 55, further comprising plotting a model validation for the model, and presenting the plot to a human user.

### DETAILED DESCRIPTION OF THE DRAWINGS

A system and method for cluster-based ML model validation will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

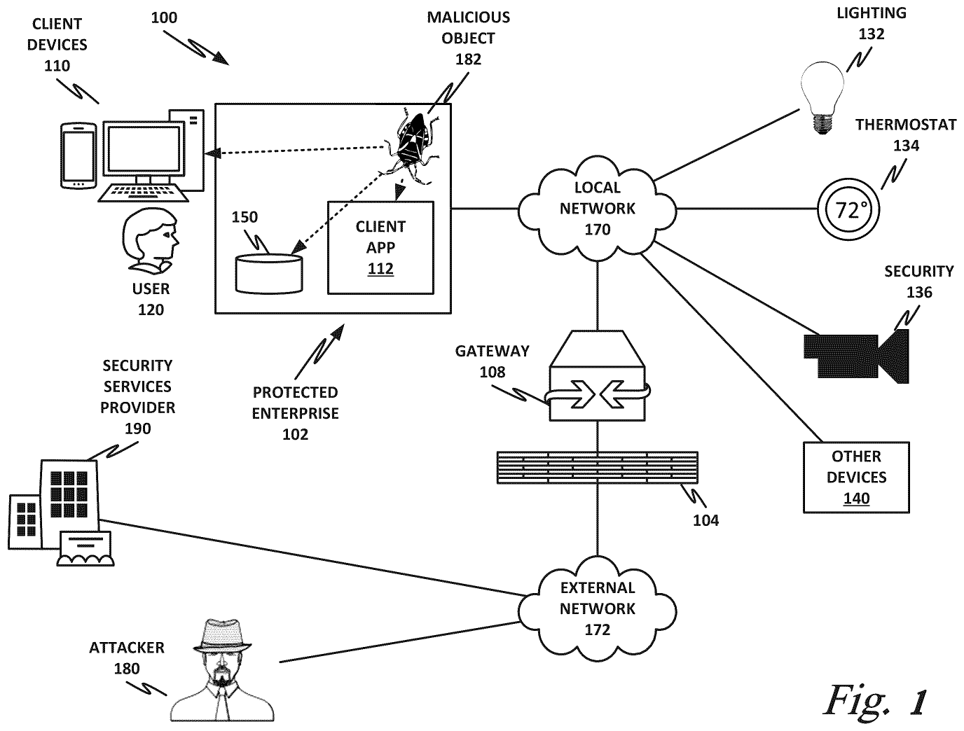

FIG. 1 is a block diagram of a security ecosystem 100. In the example of FIG. 1, security ecosystem 100 may be an enterprise, a government entity, a data center, a telecommunications provider, a “smart home” with computers, smart phones, and various internet of things (IoT) devices, or any other suitable ecosystem. Security ecosystem 100 is provided herein as an illustrative and nonlimiting example of a system that may employ, and benefit from, the teachings of the present specification.

Security ecosystem 100 may include one or more protected enterprises 102. A single protected enterprise 102 is illustrated here for simplicity, and could be a business enterprise, a government entity, a family, an individual, a nonprofit organization, a church, or any other organization that may subscribe to security services provided, for example, by security services provider 190.

Within security ecosystem 100, one or more users 120 operate one or more client devices 110. A single user 120 and single client device 110 are illustrated here for simplicity, but a home or enterprise may have multiple users, each of which may have multiple devices, such as desktop computers, laptop computers, smart phones, tablets, hybrids, or similar.

Client devices 110 may be communicatively coupled to one another and to other network resources via local network 170. Local network 170 may be any suitable network or combination of one or more networks operating on one or more suitable networking protocols, including a local area network, a home network, an intranet, a virtual network, a wide area network, a wireless network, a cellular network, or the internet (optionally accessed via a proxy, virtual machine, or other similar security mechanism) by way of nonlimiting example. Local network 170 may also include one or more servers, firewalls, routers, switches, security appliances, antivirus servers, or other network devices, which may be single-purpose appliances, virtual machines, containers, or functions. Some functions may be provided on client devices 110.

In this illustration, local network 170 is shown as a single network for simplicity, but in some embodiments, local network 170 may include any number of networks, such as one or more intranets connected to the internet. Local network 170 may also provide access to an external network, such as the internet, via external network 172. External network 172 may similarly be any suitable type of network.

Local network 170 may connect to the internet via gateway 108, which may be responsible, among other things, for providing a logical boundary between local network 170 and external network 172. Local network 170 may also provide services such as dynamic host configuration protocol (DHCP), gateway services, router services, and switching services, and may act as a security portal across local boundary 104.

In some embodiments, gateway 108 could be a simple home router, or could be a sophisticated enterprise infrastructure including routers, gateways, firewalls, security services, deep packet inspection, web servers, or other services.

In further embodiments, gateway 108 may be a standalone internet appliance. Such embodiments are popular in cases in which ecosystem 100 includes a home or small business. In other cases, gateway 108 may run as a virtual machine or in another virtualized manner. In larger enterprises that features service function chaining (SFC) or NFV, gateway 108 may be include one or more service functions and/or virtualized network functions.

Local network 170 may also include a number of discrete IoT devices. For example, local network 170 may include IoT functionality to control lighting 132, thermostats or other environmental controls 134, a security system 136, and any number of other devices 140. Other devices 140 may include, as illustrative and nonlimiting examples, network attached storage (NAS), computers, printers, smart televisions, smart refrigerators, smart vacuum cleaners and other appliances, and network connected vehicles.

Local network 170 may communicate across local boundary 104 with external network 172. Local boundary 104 may represent a physical, logical, or other boundary. External network 172 may include, for example, websites, servers, network protocols, and other network-based services. In one example, an attacker 180 (or other similar malicious or negligent actor) also connects to external network 172. A security services provider 190 may provide services to local network 170, such as security software, security updates, network appliances, or similar. For example, MCAFEE, LLC provides a comprehensive suite of security services that may be used to protect local network 170 and the various devices connected to it.

It may be a goal of users 120 to successfully operate devices on local network 170 without interference from attacker 180. In one example, attacker 180 is a malware author whose goal or purpose is to cause malicious harm or mischief, for example, by injecting malicious object 182 into client device 110. Once malicious object 182 gains access to client device 110, it may try to perform work such as social engineering of user 120, a hardware-based attack on client device 110, modifying storage 150 (or volatile memory), modifying client application 112 (which may be running in memory), or gaining access to local resources. Furthermore, attacks may be directed at IoT objects. IoT objects can introduce new security challenges, as they may be highly heterogeneous, and in some cases may be designed with minimal or no security considerations. To the extent that these devices have security, it may be added on as an afterthought. Thus, IoT devices may in some cases represent new attack vectors for attacker 180 to leverage against local network 170.

Malicious harm or mischief may take the form of installing root kits or other malware on client devices 110 to tamper with the system, installing spyware or adware to collect personal and commercial data, defacing websites, operating a botnet such as a spam server, or simply to annoy and harass users 120. Thus, one aim of attacker 180 may be to install his malware on one or more client devices 110 or any of the IoT devices described. As used throughout this specification, malicious software (“malware”) includes any object configured to provide unwanted results or do unwanted work. In many cases, malware objects will be executable objects, including, by way of nonlimiting examples, viruses, Trojans, zombies, rootkits, backdoors, worms, spyware, adware, ransomware, dialers, payloads, malicious browser helper objects, tracking cookies, loggers, or similar objects designed to take a potentially unwanted action, including, by way of nonlimiting example, data destruction, data denial, covert data collection, browser hijacking, network proxy or redirection, covert tracking, data logging, keylogging, excessive or deliberate barriers to removal, contact harvesting, and unauthorized self-propagation. In some cases, malware could also include negligently-developed software that causes such results even without specific intent.

In enterprise contexts, attacker 180 may also want to commit industrial or other espionage, such as stealing classified or proprietary data, stealing identities, or gaining unauthorized access to enterprise resources. Thus, attacker 180's strategy may also include trying to gain physical access to one or more client devices 110 and operating them without authorization, so that an effective security policy may also include provisions for preventing such access.

In another example, a software developer may not explicitly have malicious intent, but may develop software that poses a security risk. For example, a well-known and often-exploited security flaw is the so-called buffer overrun, in which a malicious user is able to enter an overlong string into an input form and thus gain the ability to execute arbitrary instructions or operate with elevated privileges on a computing device. Buffer overruns may be the result, for example, of poor input validation or use of insecure libraries, and in many cases arise in nonobvious contexts. Thus, although not malicious, a developer contributing software to an application repository or programming an IoT device may inadvertently provide attack vectors for attacker 180. Poorly-written applications may also cause inherent problems, such as crashes, data loss, or other undesirable behavior. Because such software may be desirable itself, it may be beneficial for developers to occasionally provide updates or patches that repair vulnerabilities as they become known. However, from a security perspective, these updates and patches are essentially new objects that must themselves be validated.

Protected enterprise 102 may contract with or subscribe to a security services provider 190, which may provide security services, updates, antivirus definitions, patches, products, and services. MCAFEE, LLC is a nonlimiting example of such a security services provider that offers comprehensive security and antivirus solutions. In some cases, security services provider 190 may include a threat intelligence capability such as the global threat intelligence (GTI™) database provided by MCAFEE, LLC, or similar competing products. Security services provider 190 may update its threat intelligence database by analyzing new candidate malicious objects as they appear on client networks and characterizing them as malicious or benign.

Other security considerations within security ecosystem 100 may include parents' or employers' desire to protect children or employees from undesirable content, such as pornography, adware, spyware, age-inappropriate content, advocacy for certain political, religious, or social movements, or forums for discussing illegal or dangerous activities, by way of nonlimiting example.

Protected enterprise 102 may contract with security services provider 190 for enterprise security services. As part of this contracting, security services provider 190 may provide a detection endpoint and/or enterprise network scanning software to protected enterprise 102. This software may include one or more ML models that may be used to scan individual client devices 110 and/or local network 170 to identify malicious objects 182. As discussed above, it may be desirable to validate the ML model before active deployment of the ML model. Validation may include running the new ML model in silent mode on protected enterprise 102 for several months and then comparing the results to expected results. However, this may delay activation of the new ML model for a time, such as several months. Advantageously, the teachings of the present specification provide an alternative method of validating the ML model, including using the validator described herein.

In the context of a smaller enterprise (e.g., a family or an individual), the enterprise is expected to have fewer complex objects like configuration scripts, custom installers, or enterprise applications. The disclosed validator may also be valuable in those enterprises. For example, a new popular software update can spread the same new clean file to many people. This update may have similar features to known clean files, so the validator can ensure that the new update doesn't cause false positive. On the other hand, a new malware variant that is similar to existing malware can quickly become prevalent through active attacks. In that case, the model being validated should catch the novel malware, and the model's ability to do so can be evaluated by the validator.

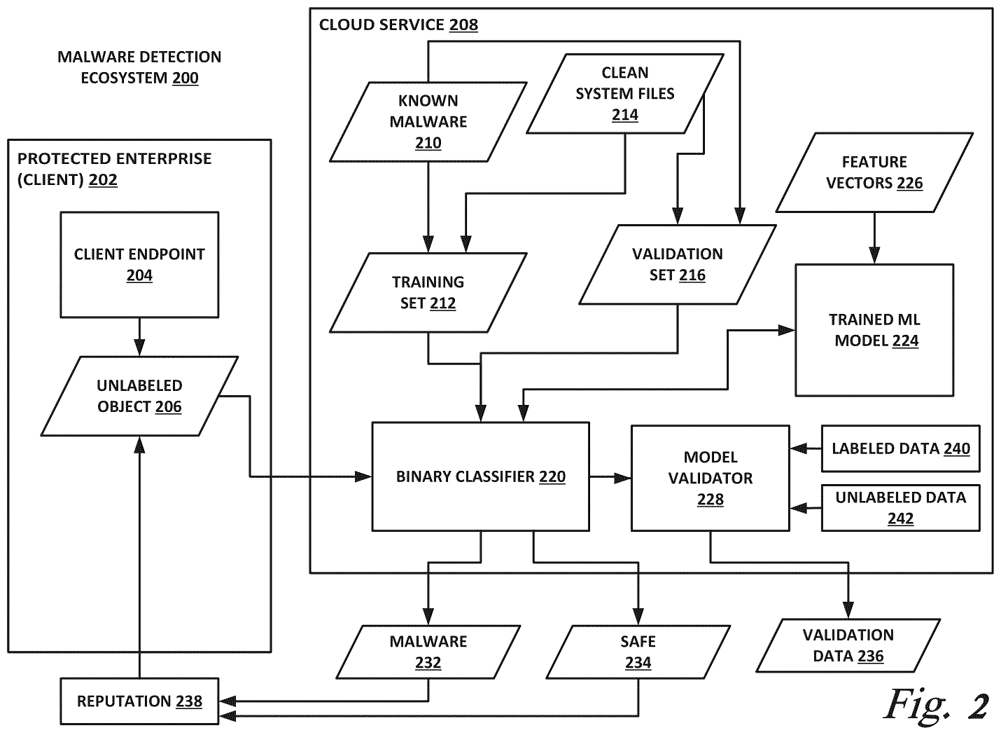

FIG. 2 is a block diagram of selected elements of a malware detection ecosystem 200. Malware detection ecosystem 200 includes a protected enterprise 202 acting as a client, and a cloud service 208 provided by the security services provider. It should be noted that this division between a cloud service and a client is provided by way of illustrative example only. In other embodiments, other configurations could be used, including providing all of the services and operations illustrated here on a single device that both manages the ML model and scans itself. In other embodiments, the various elements illustrated here may be divided between various enterprises, cloud service providers, vendors, or others.

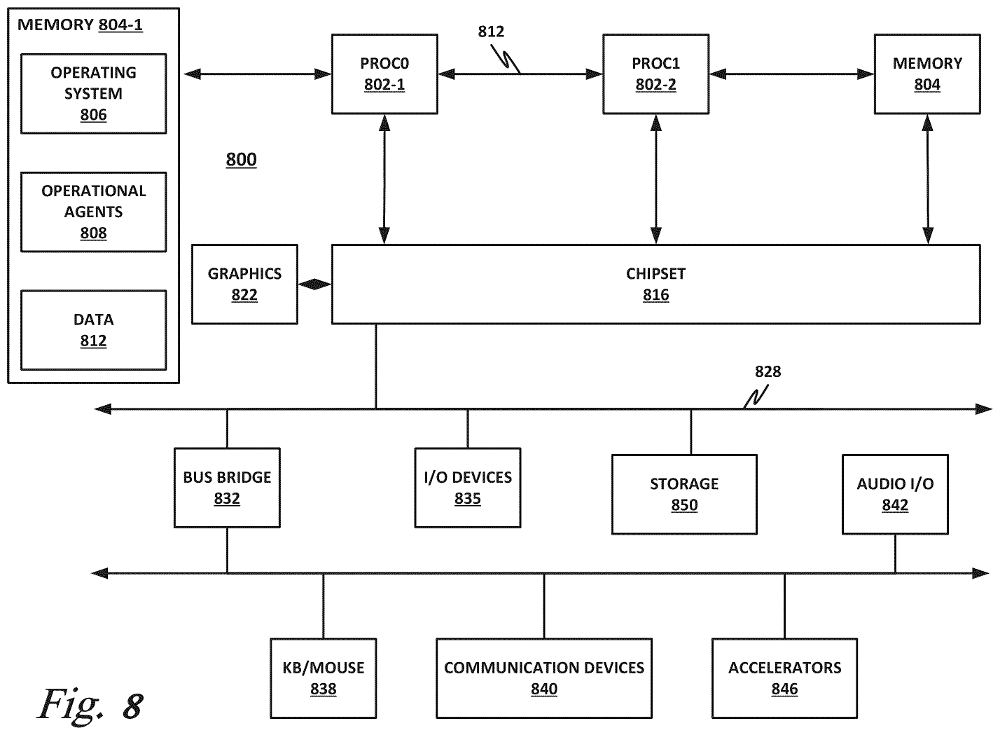

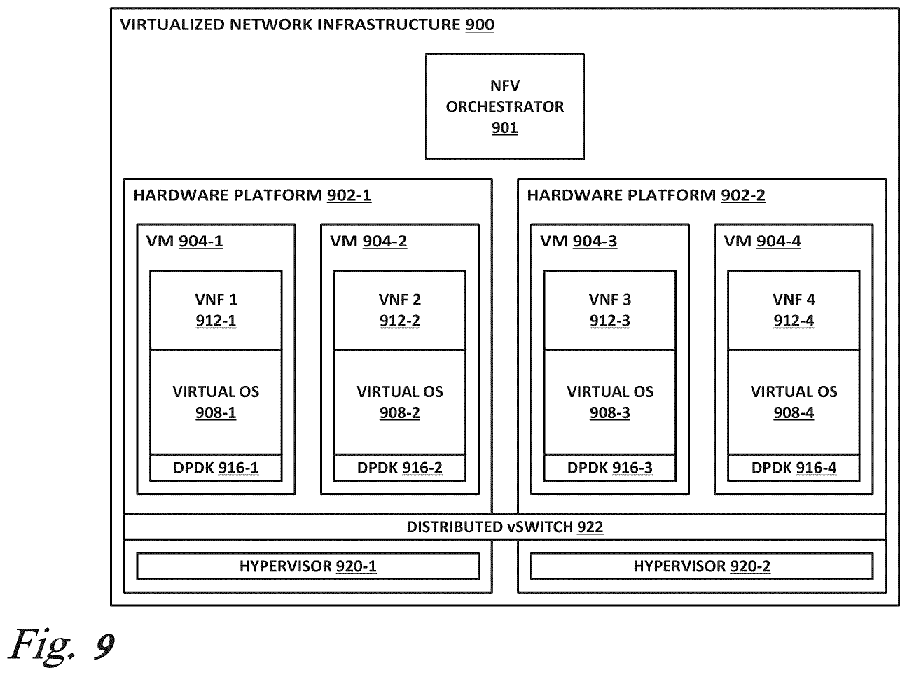

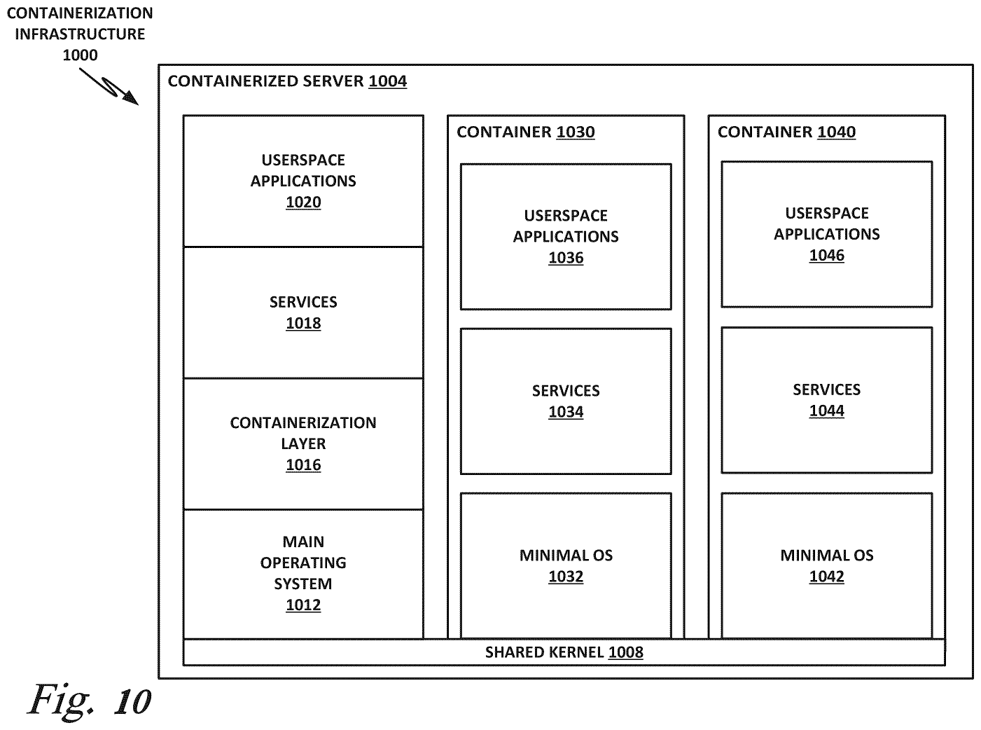

In this example, cloud service 208 may be provided on appropriate cloud infrastructure, such as the infrastructure illustrated in FIGS. 9 and 10 below. Appropriate hardware for cloud service 208 and/or protected enterprise 202 may be a hardware platform, such as hardware platform 800 illustrated in FIG. 8 below.

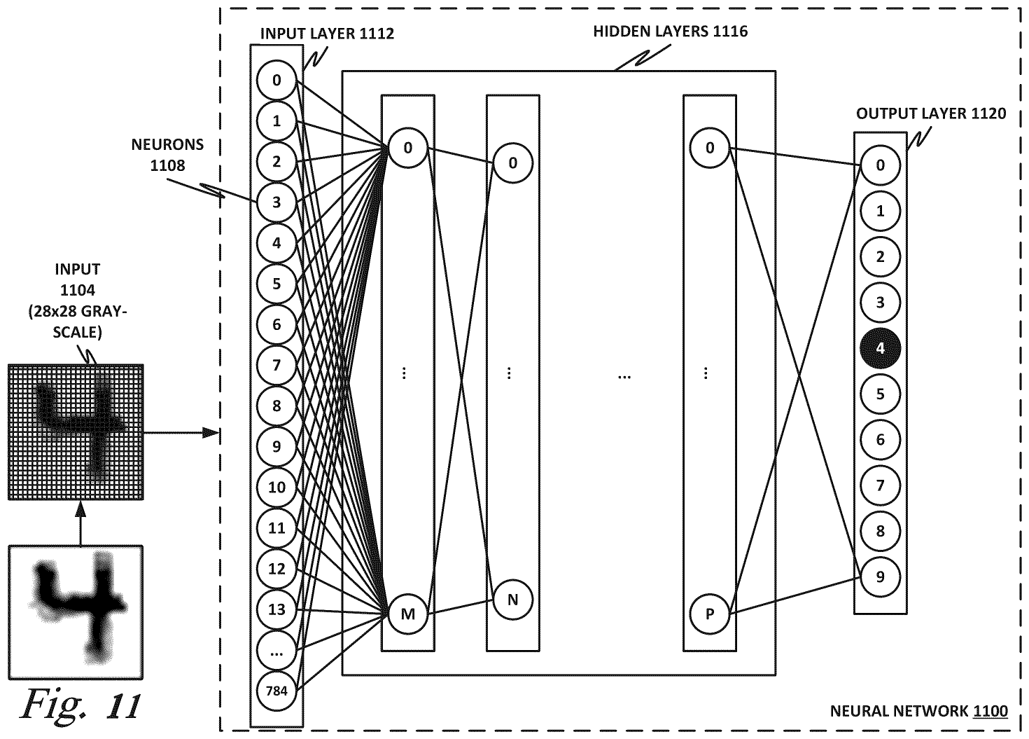

Cloud service 208 may design, train, and/or deploy a binary classifier 220, which includes a trained ML model 224. Selected elements of designing and training an ML model are illustrated in FIGS. 11 through 14 below.

Binary classifier may receive a training set 212, which may include both known malware samples 210 and clean system files 214. Again, malware classification is provided as only one illustration of binary classification according to the present specification, and other binary class fares may be used. Training set 212 receives known malware 210 and clean system files 214 and uses those to train binary classifier 220, for example, according to the method illustrated in FIGS. 11 through 14 below. Once binary classifier 220 has generated trained ML model 224, it may be desirable to validate trained ML model 224. Thus, a model validator 228 may receive feature vectors 226, which may include data from a validation set 216. Validation set 216 may include known malware 210 and clean system files 214. These may generally be illustrated as labeled data 240. These are objects that have been previously classified either by a human or by a trusted ML model and therefore have a known and trusted label. However, when the ML model is deployed on protected enterprise 202, it may also encounter a large number of unlabeled files. In validating ML model 224, model validator 228 may use unlabeled data 242. These data may include objects that are encountered on protected enterprise 202 and that do not have a known label.

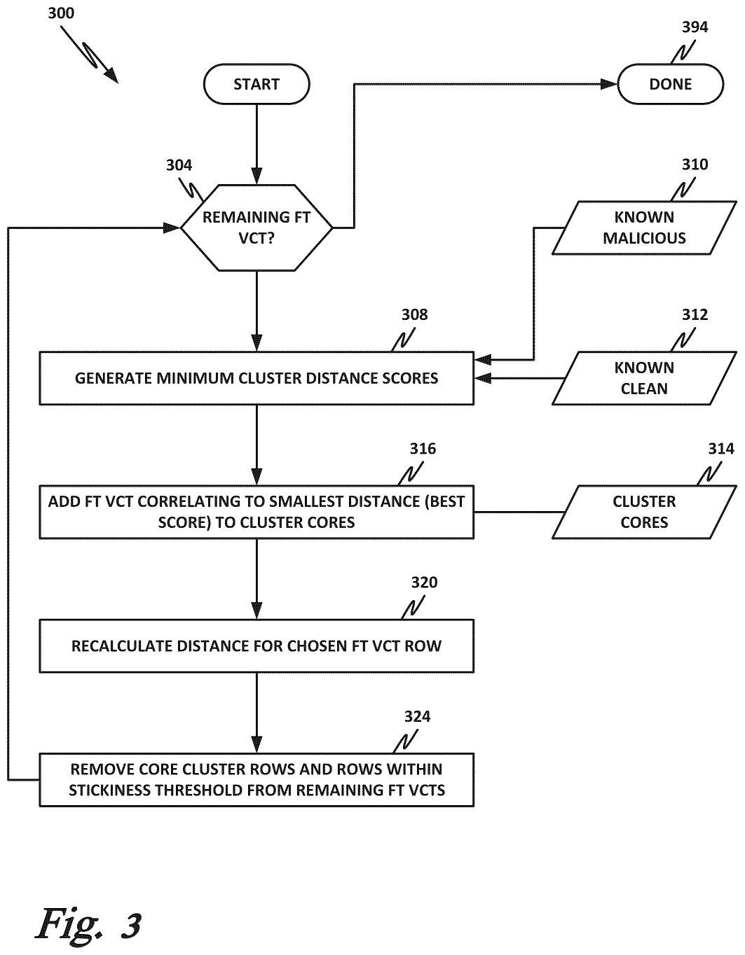

Model validator 228 may examine unlabeled data 242 and may estimate a classification for the unlabeled objects according to the methods illustrated in FIGS. 3 through 7 below. Model validator 228 may then use the estimated classification as a proxy for a known label if the confidence for the estimated classification of a particular object is high enough.

Whether in training, validation, or live operation, binary classifier 220 may operate trained model 224 to classify an unlabeled object, such as unlabeled object 206, as one of malware 232 or safe 234. In this example, unlabeled object 206 may represent an object that is encountered on protected enterprise 202, such as within client endpoint 204 or within the broader network. Protected enterprise 202 may wish to assign a trusted reputation to unlabeled object 206 so that protected enterprise 202 can make decisions about whether to trust the object, quarantine the object, or take some other action. In some cases, client endpoint 204 may run client software, and protected enterprise 202 may run enterprise software, which may include a copy of trained ML model 224. Protected enterprise 202 may not provide the full training and validation infrastructure of cloud service 208, but once ML model 224 is sufficiently trusted, then a copy of the trained model can run on the enterprise in a live deployment.

Binary classifier 220 classifies unlabeled object 206 as malware 232 or safe 234 (or some other binary classification), which yields a reputation 238. Reputation 238 may then be provided to protected enterprise 202, and protected enterprise 202 may then decide how to treat unlabeled object 206 according to reputation 238.

One aspect of validation is examining unlabeled objects found on protected enterprise 202. One challenge may be that protected enterprise 202 may not wish to share its proprietary files and data with cloud service 208. This can present a challenge to validating trained ML model 224 within the infrastructure of cloud service 208. While the validation infrastructure could be replicated within protected enterprise 202, this may not be desirable in some embodiments where protected enterprise 202 does not wish to provide the full hardware platform and cloud infrastructure desirable to provide the ML model validation. However, a local agent running on protected enterprise 202 may reduce an unlabeled object 206 to a set of feature vectors. These feature vectors can then be provided to cloud service 208 without compromising the content of the proprietary application or data. Cloud service 208 can then use that feature vector within model validator 228 to compute the distance between the feature vector and known feature vector clusters for both malware and safe objects. The shortest distance to a known feature vector cluster may then be used to estimate a label for unlabeled object 206. If unlabeled object 206 provides feature vectors that are much closer to the malware feature vector clusters, then model validator 228 may estimate with high confidence that unlabeled object 206 is a malware file. Conversely, if model validator 228 finds that the feature vectors from unlabeled object 206 are much closer to the feature vector clusters for safe objects 234, then model validator 228 may estimate with high confidence that unlabeled object 206 is safe or clean. On the other hand, if the feature vector for unlabeled object 206 is approximately equidistant to the closest feature vector cluster for malware and the closest feature vector cluster for safe, then model validator 228 may not be able to assign an estimated label with high confidence. If the confidence is below a threshold, then model validator 228 may exclude that unlabeled object from validation. Conversely, if confidence is high, then model validator 228 may use the estimated classification as a proxy for a known label during validation.

Model validator 228 may provide validation data 236, which may include composite data that can be used to assess and validate trained ML model 224. An example graph of validation data is illustrated as graph 700 of FIG. 7. This can be used to verify that cluster of objects fall within the expected error bars and to identify outliers that may require additional analysis, such as detailed analysis by a trusted ML model or by a human operator.

FIG. 3 is a flowchart of a method 300. Method 300 may be used to generate feature vector clusters from known labeled objects. These feature vector clusters can then be used to estimate a label for an unlabeled object by calculating the minimum distance to the various feature vector clusters.

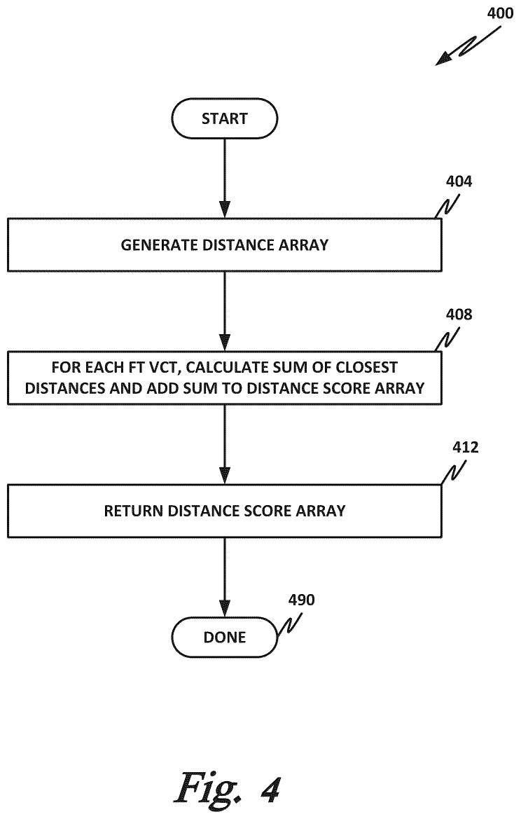

Method 300 is an iterative process wherein each feature vector is considered along with its label. The process may iterate the feature vectors of a single label, such as a set of known clean objects 312 and known malicious objects 310. In some embodiments, the feature vectors may be de-duplicated before feature vector clusters are calculated. The process of generating clusters may then be repeated to generate a separate set of clusters for the feature vectors labeled clean and for the feature vectors labeled malicious. As long as there are more feature vectors in the set to iterate over (e.g., block 304), scores are generated for each feature vector that represent the sum of the distance of the closest other feature vectors or the number of closest feature vectors to account is equal to the minimum cluster size as illustrated further in FIG. 4 below. The process of generating minimum cluster distance scores is illustrated in additional detail in FIG. 4.

Starting in block 304, the system determines whether there are feature vectors available to be analyzed. If there are no additional feature vectors (e.g., if all feature vectors have already been considered), then in block 394, the method is done.

If there are feature vectors, then the system will iterate over the remaining feature vectors.

In block 308, the system generates the minimum cluster distance score, such as according to method 400 of FIG. 4 or another appropriate method.

In block 316, the feature vector corresponding to the smallest minimum cluster distance score may be added to the set of cluster cores shown as cluster cores 314. In block 320, for the chosen cluster core feature vector, the distances to the other feature vectors may be recalculated into an array. Alternatively, those distances can be cached in memory from the generation of the minimum cluster distance scores as in block 308. In that case, it may not be necessary to recalculate the distance for the chosen feature vector row.

In block 324, the feature vectors that are closest to the cluster core are removed from the set of remaining feature vectors. Removing core cluster rows and rows within a stickiness threshold may be used to identify the furthest distance feature vector of the closest “men cluster size” number of feature vectors. This may be deemed the furthest distance of the closest, which may be abbreviated FTC. The system may determine to remove each feature vector if the distance score for that feature vector is less than or equal to the FTC plus a multiple of a configurable setting, “cluster stickiness,” which, by way of example, is a percentage times the FTC.

After calculating a cluster for a particular feature vector, the system loops back to block 304 to check for more feature vectors. If there are no more feature vectors, then in block 394, the method is done.

FIG. 4 illustrates a method 400 of generating minimum cluster distance scores. Method 400 is one available method, and other methods may be used.

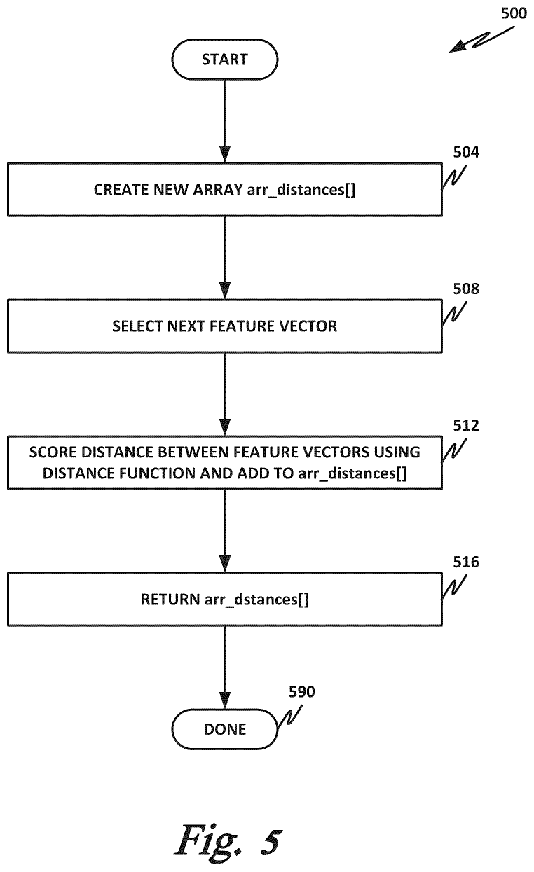

In block 404, the system generates a distance array. An illustrative method of generating a distance array is illustrated in method 500 of FIG. 5 below. The array of scores may be initialized so that each entry corresponds to a feature vector index.

In block 408, the system may calculate for each feature vector a sum of closest distances and add the sum to a distance score array.

In block 412, the system may return the distance score array, which may be used, for example, as an input into block 308 of FIG. 3 or otherwise.

In block 490, the method is done.

FIG. 5 is a flowchart of a method 500 that illustrates a process of generating a distance array. In this method, starting in block 504, a zeroed array of distances is created with indexes that match the array of feature vectors. This array may be referred to as arr_distances[ ]. As an input to this process, a given feature vector may be provided.

In block 508, the next feature vector is selected. In block 512, the distance between the given feature vector and the iterated feature vector may be calculated and added to arr_distances[ ].

In block 516, the system returns the array arr_distances[ ].

In block 590, the method is done.

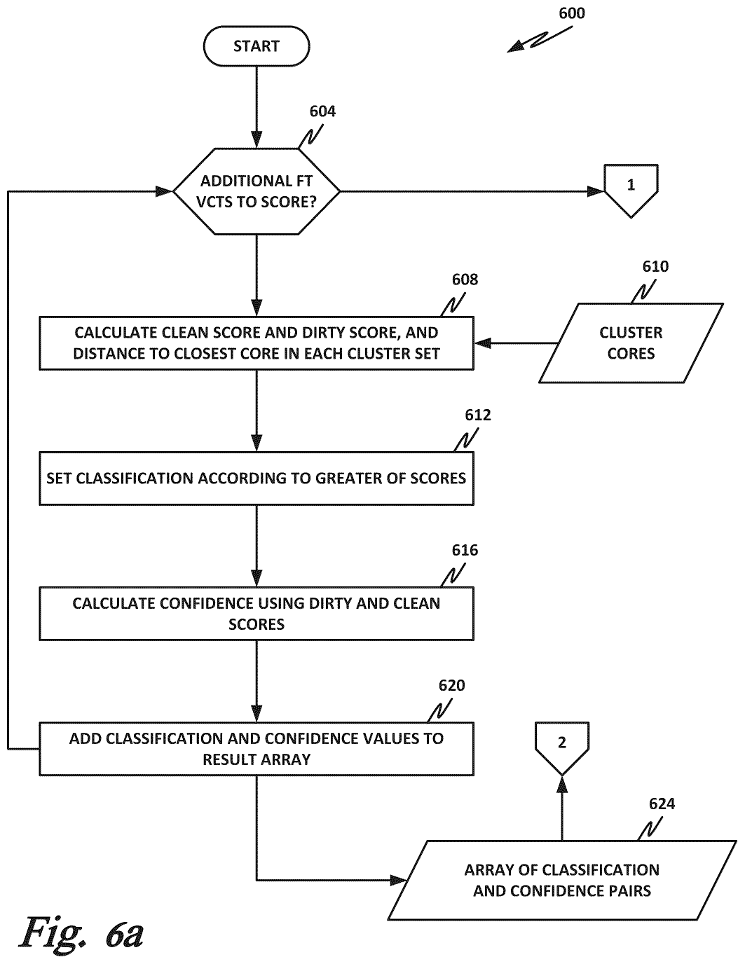

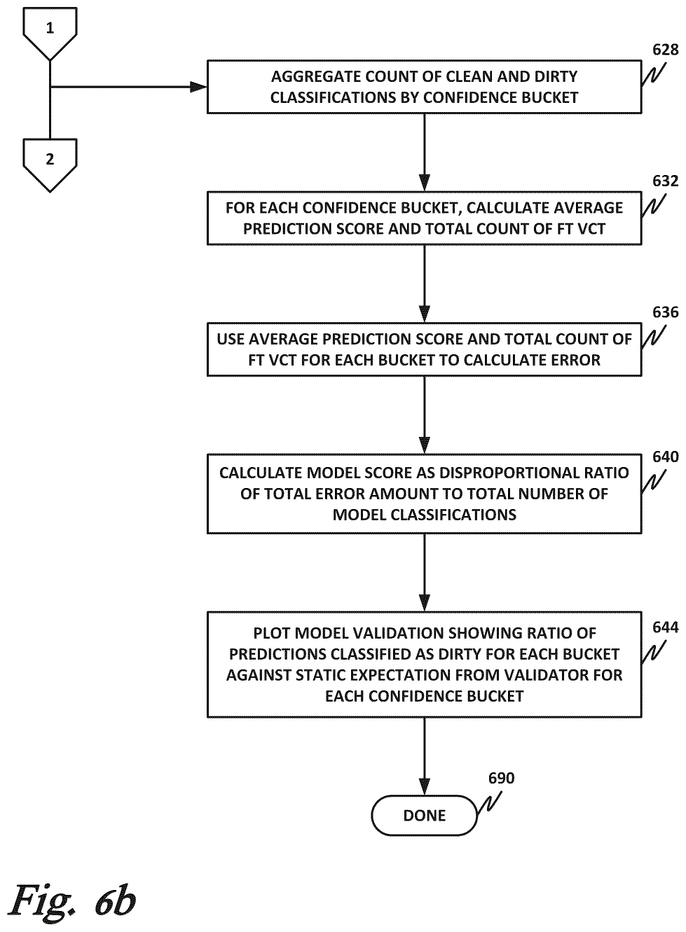

FIGS. 6A and 6B provide a method 600 of validating a model using the generated clusters. These may be viewed in conjunction with FIG. 7, which provides a validation graph. Method 600 generally uses the predicted or estimated scores and associated feature vectors corresponding to unlabeled files received from the field. These files may be processed by the ML model, and then the validator may use the estimated label and the ML model output to validate the ML model.

Method 600 is an iterative method starting in block 604 that processes each of a plurality of feature vectors to be scored. Thus, in block 604, the system determines whether there are available feature vectors to be scored. If there are feature vectors to be scored or, in other words, if there are prediction rows to process, for each row, the system calculates, in block 608, a clean score and dirty score, and the distance to the closest core in each cluster set. Block 608 receives, as in input cluster cores 610, which may have been calculated, for example, according to method 400 of FIG. 3.

Further, in block 608, for each row, a clean score and dirty score are calculated according to the cluster validator.

In block 612, the clean score is calculated to be the distance to the closest clean cluster core. The dirty score is calculated to be the distance to the closest malicious cluster core. An overall sample score from a validator may then be calculated as the clean score minus the dirty score. Thus, the validator classification or, in other words, the estimated classification may be set as clean or malicious according to which is greater between the clean score or the malicious score.

Distances may be calculated according to any suitable known distance computation method. For example, a Minkowski distance may be used, or a Jaccard distance. In some embodiments, a modified version of the Jaccard distance, referred to herein as “Jaccard B,” may be used.

The original Jaccard function may be expressed as follows:

| Row | Original Jaccard Function |
|---|---|
| 1 | $1 - \frac{{M}_{11}}{{M}_{x} + {M}_{11}}$ |
| 2 | $1 - \frac{Σ min ( A , B )}{Σ \vert A - B \vert + Σ max ( A , B )}$ |
| 3 | $1 - \frac{\vert A ⋂ B \vert}{\vert A \vert + \vert B \vert - \vert A ⋂ B \vert}$ |

The modified “Jaccard B” function adds a constant K, which can be selected to adjust the grouping of results. The modified Jaccard B functions may be expressed as follows:

| Row | Jaccard B Function |
|---|---|
| 1 | $1 - \frac{{M}_{11} + K}{{M}_{X} + {M}_{11} + K}$ |
| 2 | $1 - \frac{K + Σ min ( A , B )}{K + Σ \vert A - B \vert + Σ min ( A , B )}$ |
| 3 | $1 - \frac{\vert A ⋂ B \vert + K}{( \vert A \vert + \vert B \vert - \vert A ⋂ B \vert \vert + K )}$ |

In the foregoing, M₁₁ is the count of bits where A&B. M_{X} is the count of bits where A XORB. K is a constant, which can have several values. For example, a constant of K=1 may be used as s default. In other cases, a choice of K may depend on the size of the feature vector and the range of binned numerals. An appropriate selection of K can realize advantages. For example, a larger K may create higher score separation, thus making clusters appear farther from one another. In selected embodiments, ranges for K may be driven by the range of each value, and the density of nonzero values within each vector. In a sparse vector, for example, a smaller K may be preferable.

If K»Rangeᵥₐₗᵤₑₛ, then K dominates the result, and the starting values may be mostly lost. In one embodiment, K may be selected, from K>0 up to approximately K=7.

Any distance or similarity function involving exponentials of the feature values will weight differences that are extreme and localized to a few features over the same feature differences spread out amongst a larger set of features. The exponential may be derived from the mathematical fact of this emphasis being correct in spatial geometric distances. But this proposition may not apply to all similarity measurements that are not based in spatial distances.

For example, for Windows PowerShell features, Jaccard B may be used for Boolean values, with K=1.

Bs=(M11+1)/(MX+M11+1): Range=(approaches 0,1) Bd=1−Bs: Range=(0, approaches 1)

The same method may be applied to numerical values, where MX is replaced with Σ|A−B| and M11 may be replaced with Σ|A+B|. A Jaccard for Numericals may be expressed as:

1−(Σ(A+B)/(Σ|A−B|+Σ(A+B))

A similar Jaccard B may be expressed as:

1−((K+Σ(A+B)/(K+Σ|A−B|+Σ(A+B))

This expression may work well for binned values, such as PowerShell uses. In this example, all PowerShell binned values are between zero and seven. Alternatively, this can be done on raw values by first normalizing the values to a specific range, based on the maximum value of that feature across all feature vectors.

Another alternative is to replace Σ(A+B) with ΣMAX(A, B).

This approach allows the formula to be consistent for both the Boolean and numerical cases:

1−((K+ΣMAX(A,B))/(K+Σ|A−B|+ΣMAX(A,B)))

Weak labels slow distance uses:

Σ|A−B|/(ΣA+ΣB)

This is the Manhattan distance divided by the sum of all values. This is equivalent to:

Σ|A−B|/Σ(A+B)

This is the ratio of the differences to the total. One issue for Numericals with the above methods is that large values may hide differences of small values. So these methods may be particularly on binned values, or the values that are first normalized. With PowerShell analyses, for example, the values are binned.

By way of example, the following vectors may be provided:
A=[0, 0, 0, 0, 0, 0, 0, 0]
B=[2, 0, 0, 0, 0, 0, 0, 0]
G=[2, 2, 2, 2, 2, 2, 2, 2]

For the Manhattan-based function above, the distances AB=AG, which may be a motivation to use Jaccard B instead. For Jaccard B (K=1), AB=1−((1+2)/(1+2+2)=0.4, and AG=1−((1+16)/(1+16+16))=0.4848 . . .

In this case, Jaccard B has a higher AG than AB distance. For this data set, it may be worth choosing a K value equal to the maximum bin value.

For Jaccard B where (K=7):

AB=1−((7+2)/(7+2+2)=0.1818 . . . , AG=1−((7+16)/(7+16+16))=0.41

This can be compared to the original Jaccard distance:

AB=1−((2)/(2+2)=0.5, AG=1−((16)/(16+16))=0.5

Again, in this function, AB=AG.

In block 616, the system calculates a confidence as the absolute value of the clean score minus the dirty score (absolute difference). For normalization, the absolute difference may be divided by two.

In block 620, the model validator estimated classification and confidence value for each vector, along with the model prediction score, may be added to a results array 624. This may be an array of classification and confidence pairs.

The system may iterate through a number of feature vectors, which may correspond, for example, to individual objects found in the wild during the validation phase. As described above, these may be, in some cases, proprietary or confidential client objects that the client does not wish to share with the security services vendor. However, feature vectors can be extracted from the objects for validation purposes without disclosing the contents of the individual files. The system iterates through all of the available feature vectors until all have been scored.

After all the feature vectors have been scored, then following off page connector one to FIG. 6B, the system proceeds to block 628. Block 628 receives results array 624 as an input.

In block 628, the results array may be processed into buckets by the confidence score. In one illustrative example, buckets are defined at increments of 0.05.

In block 632, for each confidence bucket, the system calculates an average prediction score and total count of the feature vectors in that bucket.

In block 636, the system uses the average prediction score and total count of feature vectors for each bucket to calculate an error. The error bar of the model validator may be correlated with the confidence score. For example, at a confidence score of one, there is an expected zero error of the model validator's assessment. This can be seen in graph 700 of FIG. 7. The error bar is defined as an acceptable value zone 708 defined by two slanting lines. The error bar comes to a point at 716 where the confidence of 1. At a confidence of 1, there should be no allowable error in the prediction. A confidence of 1, for example, may correspond to a file that is identical to a known malicious file. Conversely, a score of −1 means a 100 percent confidence that the object is clean. This corresponds to point 718 where, for example, the object may be identical to a known clean file.

If an average predictive score for a confidence bucket is outside the error bar range, this may be an outlier of concern, such as outlier 712. This may represent a bucket where the predictions misaligned with the expected confidence for those predictions.

There is also shown in FIG. 7 a zero-confidence line 704. At the zero confidence line, the distance to the nearest dirty feature vector cluster is essentially identical to the distance to the nearest clean feature vector cluster. In that case, the validator model may have no confidence that it has correctly predicted the object as either malicious or clean. In that case, optionally, the object with zero confidence or near zero confidence may be excluded from validation. In general, a confidence threshold may be defined and only objects estimated with a label above the confidence threshold may be considered for validation purposes.

Returning to FIG. 6a, in block 640, the system may calculate a model score as a disproportional ratio of total error amount to total number of model classifications. The error amount may be calculated by summing the distance from the expected value fringe for each average bucket model prediction value. The expected value fringe for a bucket may be the expected classification according to the validator plus the error bar, which is linearly proportional to the confidence bucket.

In block 644, the system may plot the model validation showing the ratio of predictions classified as dirty for each bucket against a static expectation from the validator for each confidence bucket. Such a graph is illustrated in FIG. 7.

In block 690, the method is done.

FIG. 8 is a block diagram of a hardware platform 800. Although a particular configuration is illustrated here, there are many different configurations of hardware platforms, and this embodiment is intended to represent the class of hardware platforms that can provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Furthermore, in some embodiments, entire computing devices or platforms may be virtualized, on a single device, or in a data center where virtualization may span one or a plurality of devices. For example, in a “rackscale architecture” design, disaggregated computing resources may be virtualized into a single instance of a virtual device. In that case, all of the disaggregated resources that are used to build the virtual device may be considered part of hardware platform 800, even though they may be scattered across a data center, or even located in different data centers.

Hardware platform 800 is configured to provide a computing device. In various embodiments, a “computing device” may be or comprise, by way of nonlimiting example, a computer, workstation, server, mainframe, virtual machine (whether emulated or on a “bare metal” hypervisor), network appliance, container, IoT device, high performance computing (HPC) environment, a data center, a communications service provider infrastructure (e.g., one or more portions of an Evolved Packet Core), an in-memory computing environment, a computing system of a vehicle (e.g., an automobile or airplane), an industrial control system, embedded computer, embedded controller, embedded sensor, personal digital assistant, laptop computer, cellular telephone, internet protocol (IP) telephone, smart phone, tablet computer, convertible tablet computer, computing appliance, receiver, wearable computer, handheld calculator, or any other electronic, microelectronic, or microelectromechanical device for processing and communicating data. At least some of the methods and systems disclosed in this specification may be embodied by or carried out on a computing device.

In the illustrated example, hardware platform 800 is arranged in a point-to-point (PtP) configuration. This PtP configuration is popular for personal computer (PC) and server-type devices, although it is not so limited, and any other bus type may be used.

Hardware platform 800 is an example of a platform that may be used to implement embodiments of the teachings of this specification. For example, instructions could be stored in storage 850. Instructions could also be transmitted to the hardware platform in an ethereal form, such as via a network interface, or retrieved from another source via any suitable interconnect. Once received (from any source), the instructions may be loaded into memory 804, and may then be executed by one or more processor 802 to provide elements such as an operating system 806, operational agents 808, or data 812.

Hardware platform 800 may include several processors 802. For simplicity and clarity, only processors PROC0 802-1 and PROC1 802-2 are shown. Additional processors (such as 2, 4, 8, 16, 24, 32, 64, or 128 processors) may be provided as necessary, while in other embodiments, only one processor may be provided. Processors may have any number of cores, such as 1, 2, 4, 8, 16, 24, 32, 64, or 128 cores.

Processors 802 may be any type of processor and may communicatively couple to chipset 816 via, for example, PtP interfaces. Chipset 816 may also exchange data with other elements, such as a high performance graphics adapter 822. In alternative embodiments, any or all of the PtP links illustrated in FIG. 8 could be implemented as any type of bus, or other configuration rather than a PtP link. In various embodiments, chipset 816 may reside on the same die or package as a processor 802 or on one or more different dies or packages. Each chipset may support any suitable number of processors 802. A chipset 816 (which may be a chipset, uncore, Northbridge, Southbridge, or other suitable logic and circuitry) may also include one or more controllers to couple other components to one or more central processor units (CPU).

Two memories, 804-1 and 804-2 are shown, connected to PROC0 802-1 and PROC1 802-2, respectively. As an example, each processor is shown connected to its memory in a direct memory access (DMA) configuration, though other memory architectures are possible, including ones in which memory 804 communicates with a processor 802 via a bus. For example, some memories may be connected via a system bus, or in a data center, memory may be accessible in a remote DMA (RDMA) configuration.

Memory 804 may include any form of volatile or nonvolatile memory including, without limitation, magnetic media (e.g., one or more tape drives), optical media, flash, random access memory (RAM), double data rate RAM (DDR RAM) nonvolatile RAM (NVRAM), static RAM (SRAM), dynamic RAM (DRAM), persistent RAM (PRAM), data-centric (DC) persistent memory (e.g., Intel Optane/3D-crosspoint), cache, Layer 1 (L1) or Layer 2 (L2) memory, on-chip memory, registers, virtual memory region, read-only memory (ROM), flash memory, removable media, tape drive, cloud storage, or any other suitable local or remote memory component or components. Memory 804 may be used for short, medium, and/or long-term storage. Memory 804 may store any suitable data or information utilized by platform logic. In some embodiments, memory 804 may also comprise storage for instructions that may be executed by the cores of processors 802 or other processing elements (e.g., logic resident on chipsets 816) to provide functionality.

In certain embodiments, memory 804 may comprise a relatively low-latency volatile main memory, while storage 850 may comprise a relatively higher-latency nonvolatile memory. However, memory 804 and storage 850 need not be physically separate devices, and in some examples may represent simply a logical separation of function (if there is any separation at all). It should also be noted that although DMA is disclosed by way of nonlimiting example, DMA is not the only protocol consistent with this specification, and that other memory architectures are available.

Certain computing devices provide main memory 804 and storage 850, for example, in a single physical memory device, and in other cases, memory 804 and/or storage 850 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

Graphics adapter 822 may be configured to provide a human-readable visual output, such as a command-line interface (CLI) or graphical desktop such as Microsoft Windows, Apple OSX desktop, or a Unix/Linux X Window System-based desktop. Graphics adapter 822 may provide output in any suitable format, such as a coaxial output, composite video, component video, video graphics array (VGA), or digital outputs such as digital visual interface (DVI), FPDLink, DisplayPort, or high definition multimedia interface (HDMI), by way of nonlimiting example. In some examples, graphics adapter 822 may include a hardware graphics card, which may have its own memory and its own graphics processing unit (GPU).

Chipset 816 may be in communication with a bus 828 via an interface circuit. Bus 828 may have one or more devices that communicate over it, such as a bus bridge 832, I/O devices 835, accelerators 846, communication devices 840, and a keyboard and/or mouse 838, by way of nonlimiting example. In general terms, the elements of hardware platform 800 may be coupled together in any suitable manner. For example, a bus may couple any of the components together. A bus may include any known interconnect, such as a multi-drop bus, a mesh interconnect, a fabric, a ring interconnect, a round-robin protocol, a PtP interconnect, a serial interconnect, a parallel bus, a coherent (e.g., cache coherent) bus, a layered protocol architecture, a differential bus, or a Gunning transceiver logic (GTL) bus, by way of illustrative and nonlimiting example.

Communication devices 840 can broadly include any communication not covered by a network interface and the various I/O devices described herein. This may include, for example, various universal serial bus (USB), FireWire, Lightning, or other serial or parallel devices that provide communications.

I/O Devices 835 may be configured to interface with any auxiliary device that connects to hardware platform 800 but that is not necessarily a part of the core architecture of hardware platform 800. A peripheral may be operable to provide extended functionality to hardware platform 800, and may or may not be wholly dependent on hardware platform 800. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage, by way of nonlimiting example.

In one example, audio I/O 842 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth, or Wi-Fi audio, by way of nonlimiting example. Audio input may also be provided via similar interfaces, in an analog or digital form.

Bus bridge 832 may be in communication with other devices such as a keyboard/mouse 838 (or other input devices such as a touch screen, trackball, etc.), communication devices 840 (such as modems, network interface devices, peripheral interfaces such as PCI or PCIe, or other types of communication devices that may communicate through a network), audio I/O 842, a data storage device 850, and/or accelerators 846. In alternative embodiments, any portions of the bus architectures could be implemented with one or more PtP links.

Operating system 806 may be, for example, Microsoft Windows, Linux, UNIX, Mac OS X, iOS, MS-DOS, or an embedded or real-time operating system (including embedded or real-time flavors of the foregoing). In some embodiments, a hardware platform 800 may function as a host platform for one or more guest systems that invoke application (e.g., operational agents 808).

Operational agents 808 may include one or more computing engines that may include one or more nontransitory computer-readable mediums having stored thereon executable instructions operable to instruct a processor to provide operational functions. At an appropriate time, such as upon booting hardware platform 800 or upon a command from operating system 806 or a user or security administrator, a processor 802 may retrieve a copy of the operational agent (or software portions thereof) from storage 850 and load it into memory 804. Processor 802 may then iteratively execute the instructions of operational agents 808 to provide the desired methods or functions.

As used throughout this specification, an “engine” includes any combination of one or more logic elements, of similar or dissimilar species, operable for and configured to perform one or more methods provided by the engine. In some cases, the engine may be or include a special integrated circuit designed to carry out a method or a part thereof, a field-programmable gate array (FPGA) programmed to provide a function, a special hardware or microcode instruction, other programmable logic, and/or software instructions operable to instruct a processor to perform the method. In some cases, the engine may run as a “daemon” process, background process, terminate-and-stay-resident program, a service, system extension, control panel, bootup procedure, basic in/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware, software, and/or data, including configuration files, registry entries, application programming interfaces (APIs), and interactive or user-mode software by way of nonlimiting example.

In some cases, the function of an engine is described in terms of a “circuit” or “circuitry to” perform a particular function. The terms “circuit” and “circuitry” should be understood to include both the physical circuit, and in the case of a programmable circuit, any instructions or data used to program or configure the circuit.

Where elements of an engine are embodied in software, computer program instructions may be implemented in programming languages, such as an object code, an assembly language, or a high-level language such as OpenCL, FORTRAN, C, C++, JAVA, or HTML. These may be used with any compatible operating systems or operating environments. Hardware elements may be designed manually, or with a hardware description language such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

A network interface may be provided to communicatively couple hardware platform 800 to a wired or wireless network or fabric. A “network,” as used throughout this specification, may include any communicative platform operable to exchange data or information within or between computing devices, including, by way of nonlimiting example, a local network, a switching fabric, an ad-hoc local network, Ethernet (e.g., as defined by the IEEE 802.3 standard), Fiber Channel, InfiniBand, Wi-Fi, or other suitable standard. Intel Omni-Path Architecture (OPA), TrueScale, Ultra Path Interconnect (UPI) (formerly called QuickPath Interconnect, QPI, or KTI), FibreChannel, Ethernet, FibreChannel over Ethernet (FCoE), InfiniBand, PCI, PCIe, fiber optics, millimeter wave guide, an internet architecture, a packet data network (PDN) offering a communications interface or exchange between any two nodes in a system, a local area network (LAN), metropolitan area network (MAN), wide area network (WAN), wireless local area network (WLAN), virtual private network (VPN), intranet, plain old telephone system (POTS), or any other appropriate architecture or system that facilitates communications in a network or telephonic environment, either with or without human interaction or intervention. A network interface may include one or more physical ports that may couple to a cable (e.g., an Ethernet cable, other cable, or waveguide).

In some cases, some or all of the components of hardware platform 800 may be virtualized, in particular the processor(s) and memory. For example, a virtualized environment may run on OS 806, or OS 806 could be replaced with a hypervisor or virtual machine manager. In this configuration, a virtual machine running on hardware platform 800 may virtualize workloads. A virtual machine in this configuration may perform essentially all of the functions of a physical hardware platform.

In a general sense, any suitably-configured processor can execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

Various components of the system depicted in FIG. 8 may be combined in a SoC architecture or in any other suitable configuration. For example, embodiments disclosed herein can be incorporated into systems including mobile devices such as smart cellular telephones, tablet computers, personal digital assistants, portable gaming devices, and similar. These mobile devices may be provided with SoC architectures in at least some embodiments. An example of such an embodiment is provided in FIGURE QC. Such an SoC (and any other hardware platform disclosed herein) may include analog, digital, and/or mixed-signal, radio frequency (RF), or similar processing elements. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), FPGAs, and other semiconductor chips.

FIG. 9 is a block diagram of a NFV infrastructure 900. NFV is an example of virtualization, and the virtualization infrastructure here can also be used to realize traditional VMs. Various functions described above may be realized as VMs, such as the ML model of this specification, the training module, the validation module, and other appropriate functions.

NFV is generally considered distinct from software defined networking (SDN), but they can interoperate together, and the teachings of this specification should also be understood to apply to SDN in appropriate circumstances. For example, virtual network functions (VNFs) may operate within the data plane of an SDN deployment. NFV was originally envisioned as a method for providing reduced capital expenditure (Capex) and operating expenses (Opex) for telecommunication services. One feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, VNFs can be provisioned (“spun up”) or removed (“spun down”) to meet network demands. For example, in times of high load, more load balancing VNFs may be spun up to distribute traffic to more workload servers (which may themselves be VMs). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI), such as NFVI 900. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

In the example of FIG. 9, an NFV orchestrator 901 may manage several VNFs 912 running on an NFVI 900. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus making NFV orchestrator 901 a valuable system resource. Note that NFV orchestrator 901 may provide a browser-based or graphical configuration interface, and in some embodiments may be integrated with SDN orchestration functions.

Note that NFV orchestrator 901 itself may be virtualized (rather than a special-purpose hardware appliance). NFV orchestrator 901 may be integrated within an existing SDN system, wherein an operations support system (OSS) manages the SDN. This may interact with cloud resource management systems (e.g., OpenStack) to provide NFV orchestration. An NFVI 900 may include the hardware, software, and other infrastructure to enable VNFs to run. This may include a hardware platform 902 on which one or more VMs 904 may run. For example, hardware platform 902-1 in this example runs VMs 904-1 and 904-2. Hardware platform 902-2 runs VMs 904-3 and 904-4. Each hardware platform 902 may include a respective hypervisor 920, virtual machine manager (VMM), or similar function, which may include and run on a native (bare metal) operating system, which may be minimal so as to consume very few resources. For example, hardware platform 902-1 has hypervisor 920-1, and hardware platform 902-2 has hypervisor 920-2.

Hardware platforms 902 may be or comprise a rack or several racks of blade or slot servers (including, e.g., processors, memory, and storage), one or more data centers, other hardware resources distributed across one or more geographic locations, hardware switches, or network interfaces. An NFVI 900 may also include the software architecture that enables hypervisors to run and be managed by NFV orchestrator 901.

Running on NFVI 900 are VMs 904, each of which in this example is a VNF providing a virtual service appliance. Each VM 904 in this example includes an instance of the Data Plane Development Kit (DPDK) 916, a virtual operating system 908, and an application providing the VNF 912. For example, VM 904-1 has virtual OS 908-1, DPDK 916-1, and VNF 912-1. VM 904-2 has virtual OS 908-2, DPDK 916-2, and VNF 912-2. VM 904-3 has virtual OS 908-3, DPDK 916-3, and VNF 912-3. VM 904-4 has virtual OS 908-4, DPDK 916-4, and VNF 912-4.

Virtualized network functions could include, as nonlimiting and illustrative examples, firewalls, intrusion detection systems, load balancers, routers, session border controllers, DPI services, network address translation (NAT) modules, or call security association.

The illustration of FIG. 9 shows that a number of VNFs 904 have been provisioned and exist within NFVI 900. This FIGURE does not necessarily illustrate any relationship between the VNFs and the larger network, or the packet flows that NFVI 900 may employ.

The illustrated DPDK instances 916 provide a set of highly-optimized libraries for communicating across a virtual switch (vSwitch) 922. Like VMs 904, vSwitch 922 is provisioned and allocated by a hypervisor 920. The hypervisor uses a network interface to connect the hardware platform to the data center fabric (e.g., a host fabric interface (HFI)). This HFI may be shared by all VMs 904 running on a hardware platform 902. Thus, a vSwitch may be allocated to switch traffic between VMs 904. The vSwitch may be a pure software vSwitch (e.g., a shared memory vSwitch), which may be optimized so that data are not moved between memory locations, but rather, the data may stay in one place, and pointers may be passed between VMs 904 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 922 is illustrated, wherein vSwitch 922 is shared between two or more physical hardware platforms 902.

FIG. 10 is a block diagram of selected elements of a containerization infrastructure 1000. Like virtualization, containerization is a popular form of providing a guest infrastructure. Various functions described herein may be containerized, such as the ML model, the training module, the validation module, or other appropriate functions.

Containerization infrastructure 1000 runs on a hardware platform such as containerized server 1004. Containerized server 1004 may provide processors, memory, one or more network interfaces, accelerators, and/or other hardware resources.

Running on containerized server 1004 is a shared kernel 1008. One distinction between containerization and virtualization is that containers run on a common kernel with the main operating system and with each other. In contrast, in virtualization, the processor and other hardware resources are abstracted or virtualized, and each virtual machine provides its own kernel on the virtualized hardware.

Running on shared kernel 1008 is main operating system 1012. Commonly, main operating system 1012 is a Unix or Linux-based operating system, although containerization infrastructure is also available for other types of systems, including Microsoft Windows systems and Macintosh systems. Running on top of main operating system 1012 is a containerization layer 1016. For example, Docker is a popular containerization layer that runs on a number of operating systems, and relies on the Docker daemon. Newer operating systems (including Fedora Linux 32 and later) that use version 2 of the kernel control groups service (cgroups v2) feature appear to be incompatible with the Docker daemon. Thus, these systems may run with an alternative known as Podman that provides a containerization layer without a daemon.

Various factions debate the advantages and/or disadvantages of using a daemon-based containerization layer (e.g., Docker) versus one without a daemon (e.g., Podman). Such debates are outside the scope of the present specification, and when the present specification speaks of containerization, it is intended to include any containerization layer, whether it requires the use of a daemon or not.

Main operating system 1012 may also provide services 1018, which provide services and interprocess communication to userspace applications 1020.

Services 1018 and userspace applications 1020 in this illustration are independent of any container.

As discussed above, a difference between containerization and virtualization is that containerization relies on a shared kernel. However, to maintain virtualization-like segregation, containers do not share interprocess communications, services, or many other resources. Some sharing of resources between containers can be approximated by permitting containers to map their internal file systems to a common mount point on the external file system. Because containers have a shared kernel with the main operating system 1012, they inherit the same file and resource access permissions as those provided by shared kernel 1008. For example, one popular application for containers is to run a plurality of web servers on the same physical hardware. The Docker daemon provides a shared socket, docker.sock, that is accessible by containers running under the same Docker daemon. Thus, one container can be configured to provide only a reverse proxy for mapping hypertext transfer protocol (HTTP) and hypertext transfer protocol secure (HTTPS) requests to various containers. This reverse proxy container can listen on docker.sock for newly spun up containers. When a container spins up that meets certain criteria, such as by specifying a listening port and/or virtual host, the reverse proxy can map HTTP or HTTPS requests to the specified virtual host to the designated virtual port. Thus, only the reverse proxy host may listen on ports 80 and 443, and any request to subdomainl.example.com may be directed to a virtual port on a first container, while requests to subdomain2.example.com may be directed to a virtual port on a second container.

Other than this limited sharing of files or resources, which generally is explicitly configured by an administrator of containerized server 1004, the containers themselves are completely isolated from one another. However, because they share the same kernel, it is relatively easier to dynamically allocate compute resources such as CPU time and memory to the various containers. Furthermore, it is common practice to provide only a minimum set of services on a specific container, and the container does not need to include a full bootstrap loader because it shares the kernel with a containerization host (i.e. containerized server 1004).

Thus, “spinning up” a container is often relatively faster than spinning up a new virtual machine that provides a similar service. Furthermore, a containerization host does not need to virtualize hardware resources, so containers access those resources natively and directly. While this provides some theoretical advantages over virtualization, modern hypervisors—especially type 1, or “bare metal,” hypervisors—provide such near-native performance that this advantage may not always be realized.

In this example, containerized server 1004 hosts two containers, namely container 1030 and container 1040.

Container 1030 may include a minimal operating system 1032 that runs on top of shared kernel 1008. Note that a minimal operating system is provided as an illustrative example, and is not mandatory. In fact, container 1030 may perform as full an operating system as is necessary or desirable. Minimal operating system 1032 is used here as an example simply to illustrate that in common practice, the minimal operating system necessary to support the function of the container (which in common practice, is a single or monolithic function) is provided.

On top of minimal operating system 1032, container 1030 may provide one or more services 1034. Finally, on top of services 1034, container 1030 may also provide userspace applications 1036, as necessary.

Container 1040 may include a minimal operating system 1042 that runs on top of shared kernel 1008. Note that a minimal operating system is provided as an illustrative example, and is not mandatory. In fact, container 1040 may perform as full an operating system as is necessary or desirable. Minimal operating system 1042 is used here as an example simply to illustrate that in common practice, the minimal operating system necessary to support the function of the container (which in common practice, is a single or monolithic function) is provided.

On top of minimal operating system 1042, container 1040 may provide one or more services 1044. Finally, on top of services 1044, container 1040 may also provide userspace applications 1046, as necessary.

Using containerization layer 1016, containerized server 1004 may run discrete containers, each one providing the minimal operating system and/or services necessary to provide a particular function. For example, containerized server 1004 could include a mail server, a web server, a secure shell server, a file server, a weblog, cron services, a database server, and many other types of services. In theory, these could all be provided in a single container, but security and modularity advantages are realized by providing each of these discrete functions in a discrete container with its own minimal operating system necessary to provide those services.

FIGS. 11-13 illustrate selected elements of an artificial intelligence system or architecture. In these FIGURES, an elementary neural network is used as a representative embodiment of an artificial intelligence or machine learning architecture or engine. This should be understood to be a nonlimiting example, and other machine learning or artificial intelligence architectures are available, including for example symbolic learning, robotics, computer vision, pattern recognition, statistical learning, speech recognition, natural language processing, deep learning, convolutional neural networks, recurrent neural networks, object recognition and/or others.

FIG. 11 illustrates machine learning according to a “textbook” problem with real-world applications. In this case, a neural network 1100 is tasked with recognizing characters. To simplify the description, neural network 1100 is tasked only with recognizing single digits in the range of 0 through 9. These are provided as an input image 1104. In this example, input image 1104 is a 28×28-pixel 8-bit grayscale image. In other words, input image 1104 is a square that is 28 pixels wide and 28 pixels high. Each pixel has a value between 0 and 255, with 0 representing white or no color, and 255 representing black or full color, with values in between representing various shades of gray. This provides a straightforward problem space to illustrate the operative principles of a neural network. Only selected elements of neural network 1100 are illustrated in this FIGURE, and that real-world applications may be more complex, and may include additional features, such as the use of multiple channels (e.g., for a color image, there may be three distinct channels for red, green, and blue). Additional layers of complexity or functions may be provided in a neural network, or other artificial intelligence architecture, to meet the demands of a particular problem. Indeed, the architecture here is sometimes referred to as the “Hello World” problem of machine learning, and is provided as but one example of how the machine learning or artificial intelligence functions of the present specification could be implemented.

In this case, neural network 1100 includes an input layer 1112 and an output layer 1120. In principle, input layer 1112 receives an input such as input image 1104, and at output layer 1120, neural network 1100 “lights up” a perceptron that indicates which character neural network 1100 thinks is represented by input image 1104.

Between input layer 1112 and output layer 1120 are some number of hidden layers 1116. The number of hidden layers 1116 will depend on the problem to be solved, the available compute resources, and other design factors. In general, the more hidden layers 1116, and the more neurons per hidden layer, the more accurate the neural network 1100 may become. However, adding hidden layers and neurons also increases the complexity of the neural network, and its demand on compute resources. Thus, some design skill is required to determine the appropriate number of hidden layers 1116, and how many neurons are to be represented in each hidden layer 1116.

Input layer 1112 includes, in this example, 784 “neurons” 1108. Each neuron of input layer 1112 receives information from a single pixel of input image 1104. Because input image 1104 is a 28×28 grayscale image, it has 784 pixels. Thus, each neuron in input layer 1112 holds 8 bits of information, taken from a pixel of input image 1104. This 8-bit value is the “activation” value for that neuron.

Each neuron in input layer 1112 has a connection to each neuron in the first hidden layer in the network. In this example, the first hidden layer has neurons labeled 0 through M. Each of the M+1 neurons is connected to all 784 neurons in input layer 1112. Each neuron in hidden layer 1116 includes a kernel or transfer function, which is described in greater detail below. The kernel or transfer function determines how much “weight” to assign each connection from input layer 1112. In other words, a neuron in hidden layer 1116 may think that some pixels are more important to its function than other pixels. Based on this transfer function, each neuron computes an activation value for itself, which may be for example a decimal number between 0 and 1.

A common operation for the kernel is convolution, in which case the neural network may be referred to as a “convolutional neural network” (CNN). The case of a network with multiple hidden layers between the input layer and output layer may be referred to as a “deep neural network” (DNN). A DNN may be a CNN, and a CNN may be a DNN, but neither expressly implies the other.

Each neuron in this layer is also connected to each neuron in the next layer, which has neurons from 0 to N. As in the previous layer, each neuron has a transfer function that assigns a particular weight to each of its M+1 connections and computes its own activation value. In this manner, values are propagated along hidden layers 1116, until they reach the last layer, which has P+1 neurons labeled 0 through P. Each of these P+1 neurons has a connection to each neuron in output layer 1120. Output layer 1120 includes a number of neurons known as perceptrons that compute an activation value based on their weighted connections to each neuron in the last hidden layer 1116. The final activation value computed at output layer 1120 may be thought of as a “probability” that input image 1104 is the value represented by the perceptron. For example, if neural network 1100 operates perfectly, then perceptron 4 would have a value of 1.00, while each other perceptron would have a value of 0.00. This would represent a theoretically perfect detection. In practice, detection is not generally expected to be perfect, but it is desirable for perceptron 4 to have a value close to 1, while the other perceptrons have a value close to 0.

Conceptually, neurons in the hidden layers 1116 may correspond to “features.” For example, in the case of computer vision, the task of recognizing a character may be divided into recognizing features such as the loops, lines, curves, or other features that make up the character. Recognizing each loop, line, curve, etc., may be further divided into recognizing smaller elements (e.g., line or curve segments) that make up that feature. Moving through the hidden layers from left to right, it is often expected and desired that each layer recognizes the “building blocks” that make up the features for the next layer. In practice, realizing this effect is itself a nontrivial problem, and may require greater sophistication in programming and training than is fairly represented in this simplified example.

The activation value for neurons in the input layer is simply the value taken from the corresponding pixel in the bitmap. The activation value (a) for each neuron in succeeding layers is computed according to a transfer function, which accounts for the “strength” of each of its connections to each neuron in the previous layer. The transfer can be written as a sum of weighted inputs (i.e., the activation value (a) received from each neuron in the previous layer, multiplied by a weight representing the strength of the neuron-to-neuron connection (w)), plus a bias value.

The weights may be used, for example, to “select” a region of interest in the pixmap that corresponds to a “feature” that the neuron represents. Positive weights may be used to select the region, with a higher positive magnitude representing a greater probability that a pixel in that region (if the activation value comes from the input layer) or a subfeature (if the activation value comes from a hidden layer) corresponds to the feature. Negative weights may be used for example to actively “de-select” surrounding areas or subfeatures (e.g., to mask out lighter values on the edge), which may be used for example to clean up noise on the edge of the feature. Pixels or subfeatures far removed from the feature may have for example a weight of zero, meaning those pixels should not contribute to examination of the feature.

The bias (b) may be used to set a “threshold” for detecting the feature. For example, a large negative bias indicates that the “feature” should be detected only if it is strongly detected, while a large positive bias makes the feature much easier to detect.

The biased weighted sum yields a number with an arbitrary sign and magnitude. This real number can then be normalized to a final value between 0 and 1, representing (conceptually) a probability that the feature this neuron represents was detected from the inputs received from the previous layer. Normalization may include a function such as a step function, a sigmoid, a piecewise linear function, a Gaussian distribution, a linear function or regression, or the popular “rectified linear unit” (ReLU) function. In the examples of this specification, a sigmoid function notation (σ) is used by way of illustrative example, but it should be understood to stand for any normalization function or algorithm used to compute a final activation value in a neural network.

The transfer function for each neuron in a layer yields a scalar value. For example, the activation value for neuron “0” in layer “1” (the first hidden layer), may be written as:

a₀⁽¹⁾=σ(w₀a₀⁽⁰⁾+wᵢa₁⁽⁰⁾+ . . . w₇₈₃a₇₈₃⁽⁰⁾+b)

In this case, it is assumed that layer 0 (input layer 1112) has 784 neurons. Where the previous layer has “n” neurons, the function can be generalized as:

a₀⁽¹⁾=σ(w₀a₀⁽⁰⁾+w₁a₁⁽⁰⁾+ . . . wₙaₙ⁽⁰⁾+b)

A similar function is used to compute the activation value of each neuron in layer 1 (the first hidden layer), weighted with that neuron's strength of connections to each neuron in layer 0, and biased with some threshold value. As discussed above, the sigmoid function shown here is intended to stand for any function that normalizes the output to a value between 0 and 1.

The full transfer function for layer 1 (with k neurons in layer 1) may be written in matrix notation as:

$${a}^{( 1 )} = σ ( [ \begin{matrix}{w}_{0 , 0} & ⋯ & {w}_{0 , n} \\ ⋮ & ⋱ & ⋮ \\ {w}_{( k , 0 )} & ⋯ & {w}_{k , n}\end{matrix} ] [ \begin{matrix}{a}_{0}^{( 0 )} \\ ⋮ \\ {a}_{n}^{( 0 )}\end{matrix} ] + [ \begin{matrix}{b}_{0} \\ ⋮ \\ {b}_{n}\end{matrix} ] )$$

More compactly, the full transfer function for layer 1 can be written in vector notation as:

a⁽¹⁾=σ(Wa⁽⁰⁾+b)

Neural connections and activation values are propagated throughout the hidden layers 1116 of the network in this way, until the network reaches output layer 1120. At output layer 1120, each neuron is a “bucket” or classification, with the activation value representing a probability that the input object should be classified to that perceptron. The classifications may be mutually exclusive or multinominal. For example, in the computer vision example of character recognition, a character may best be assigned only one value, or in other words, a single character is not expected to be simultaneously both a “4” and a “9.” In that case, the neurons in output layer 1120 are binomial perceptrons. Ideally, only one value is above the threshold, causing the perceptron to metaphorically “light up,” and that value is selected. In the case where multiple perceptrons light up, the one with the highest probability may be selected. The result is that only one value (in this case, “4”) should be lit up, while the rest should be “dark.” Indeed, if the neural network were theoretically perfect, the “4” neuron would have an activation value of 1.00, while each other neuron would have an activation value of 0.00.

In the case of multinominal perceptrons, more than one output may be lit up. For example, a neural network may determine that a particular document has high activation values for perceptrons corresponding to several departments, such as Accounting, Information Technology (IT), and Human Resources. On the other hand, the activation values for perceptrons for Legal, Manufacturing, and Shipping are low. In the case of multinominal classification, a threshold may be defined, and any neuron in the output layer with a probability above the threshold may be considered a “match” (e.g., the document is relevant to those departments). Those below the threshold are considered not a match (e.g., the document is not relevant to those departments).

The weights and biases of the neural network act as parameters, or “controls,” wherein features in a previous layer are detected and recognized. When the neural network is first initialized, the weights and biases may be assigned randomly or pseudo-randomly. Thus, because the weights-and-biases controls are garbage, the initial output is expected to be garbage. In the case of a “supervised” learning algorithm, the network is refined by providing a “training” set, which includes objects with known results. Because the correct answer for each object is known, training sets can be used to iteratively move the weights and biases away from garbage values, and toward more useful values.

A common method for refining values includes “gradient descent” and “back-propagation.” An illustrative gradient descent method includes computing a “cost” function, which measures the error in the network. For example, in the illustration, the “4” perceptron ideally has a value of “1.00,” while the other perceptrons have an ideal value of “0.00.” The cost function takes the difference between each output and its ideal value, squares the difference, and then takes a sum of all of the differences. Each training example will have its own computed cost. Initially, the cost function is very large, because the network does not know how to classify objects. As the network is trained and refined, the cost function value is expected to get smaller, as the weights and biases are adjusted toward more useful values.

With, for example, 100,000 training examples in play, an average cost (e.g., a mathematical mean) can be computed across all 100,00 training examples. This average cost provides a quantitative measurement of how “badly” the neural network is doing its detection job.

The cost function can thus be thought of as a single, very complicated formula, where the inputs are the parameters (weights and biases) of the network. Because the network may have thousands or even millions of parameters, the cost function has thousands or millions of input variables. The output is a single value representing a quantitative measurement of the error of the network. The cost function can be represented as:

C(w)

Wherein w is a vector containing all of the parameters (weights and biases) in the network. The minimum (absolute and/or local) can then be represented as a trivial calculus problem, namely:

$$\frac{dC}{dw} ( w ) = 0$$

Solving such a problem symbolically may be prohibitive, and in some cases not even possible, even with heavy computing power available. Rather, neural networks commonly solve the minimizing problem numerically. For example, the network can compute the slope of the cost function at any given point, and then shift by some small amount depending on whether the slope is positive or negative. The magnitude of the adjustment may depend on the magnitude of the slope. For example, when the slope is large, it is expected that the local minimum is “far away,” so larger adjustments are made. As the slope lessens, smaller adjustments are made to avoid badly overshooting the local minimum. In terms of multi-vector calculus, this is a gradient function of many variables:

−∇C(w)

The value of −∇C is simply a vector of the same number of variables as w, indicating which direction is “down” for this multivariable cost function. For each value in −∇C, the sign of each scalar tells the network which “direction” the value needs to be nudged, and the magnitude of each scalar can be used to infer which values are most “important” to change.

Gradient descent involves computing the gradient function, taking a small step in the “downhill” direction of the gradient (with the magnitude of the step depending on the magnitude of the gradient), and then repeating until a local minimum has been found within a threshold.

While finding a local minimum is relatively straightforward once the value of −∇C, finding an absolutel minimum is many times harder, particularly when the function has thousands or millions of variables. Thus, common neural networks consider a local minimum to be “good enough,” with adjustments possible if the local minimum yields unacceptable results. Because the cost function is ultimately an average error value over the entire training set, minimizing the cost function yields a (locally) lowest average error.

In many cases, the most difficult part of gradient descent is computing the value of −∇C. As mentioned above, computing this symbolically or exactly would be prohibitively difficult. A more practical method is to use back-propagation to numerically approximate a value for −∇C. Back-propagation may include, for example, examining an individual perceptron at the output layer, and determining an average cost value for that perceptron across the whole training set. Taking the “4” perceptron as an example, if the input image is a 4, it is desirable for the perceptron to have a value of 1.00, and for any input images that are not a 4, it is desirable to have a value of 0.00. Thus, an overall or average desired adjustment for the “4” perceptron can be computed.

However, the perceptron value is not hard-coded, but rather depends on the activation values received from the previous layer. The parameters of the perceptron itself (weights and bias) can be adjusted, but it may also be desirable to receive different activation values from the previous layer. For example, where larger activation values are received from the previous layer, the weight is multiplied by a larger value, and thus has a larger effect on the final activation value of the perceptron. The perceptron metaphorically “wishes” that certain activations from the previous layer were larger or smaller. Those wishes can be back-propagated to the previous layer neurons.

At the next layer, the neuron accounts for the wishes from the next downstream layer in determining its own preferred activation value. Again, at this layer, the activation values are not hard-coded. Each neuron can adjust its own weights and biases, and then back-propagate changes to the activation values that it wishes would occur. The back-propagation continues, layer by layer, until the weights and biases of the first hidden layer are set. This layer cannot back-propagate desired changes to the input layer, because the input layer receives activation values directly from the input image.

After a round of such nudging, the network may receive another round of training with the same or a different training data set, and the process is repeated until a local and/or global minimum value is found for the cost function.

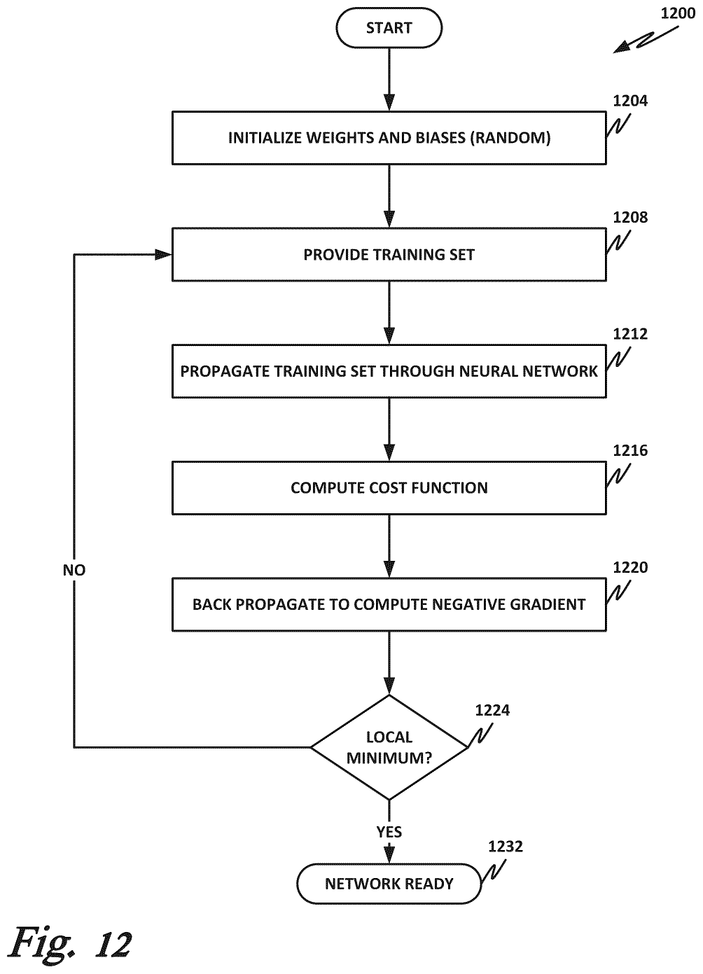

FIG. 12 is a flowchart of a method 1200. Method 1200 may be used to train a neural network, such as neural network 1100 of FIG. 11.

In block 1204, the network is initialized. Initially, neural network 1100 includes some number of neurons. Each neuron includes a transfer function or kernel. In the case of a neural network, each neuron includes parameters such as the weighted sum of values of each neuron from the previous layer, plus a bias. The final value of the neuron may be normalized to a value between 0 and 1, using a function such as the sigmoid or ReLU. Because the untrained neural network knows nothing about its problem space, and because it would be very difficult to manually program the neural network to perform the desired function, the parameters for each neuron may initially be set to just some random value. For example, the values may be selected using a pseudorandom number generator of a CPU, and then assigned to each neuron.

In block 1208, the neural network is provided a training set. In some cases, the training set may be divided up into smaller groups. For example, if the training set has 100,000 objects, this may be divided into 1,000 groups, each having 100 objects. These groups can then be used to incrementally train the neural network. In block 1208, the initial training set is provided to the neural network. Alternatively, the full training set could be used in each iteration.

In block 1212, the training data are propagated through the neural network. Because the initial values are random, and are therefore essentially garbage, it is expected that the output will also be a garbage value. In other words, if neural network 1100 of FIG. 11 has not been trained, when input image 1104 is fed into the neural network, it is not expected with the first training set that output layer 1120 will light up perceptron 4. Rather, the perceptrons may have values that are all over the map, with no clear winner, and with very little relation to the number 4.

In block 1216, a cost function is computed as described above. For example, in neural network 1100, it is desired for perceptron 4 to have a value of 1.00, and for each other perceptron to have a value of 0.00. The difference between the desired value and the actual output value is computed and squared. Individual cost functions can be computed for each training input, and the total cost function for the network can be computed as an average of the individual cost functions.

In block 1220, the network may then compute a negative gradient of this cost function to seek a local minimum value of the cost function, or in other words, the error. For example, the system may use back-propagation to seek a negative gradient numerically. After computing the negative gradient, the network may adjust parameters (weights and biases) by some amount in the “downward” direction of the negative gradient.

After computing the negative gradient, in decision block 1224, the system determines whether it has reached a local minimum (e.g., whether the gradient has reached 0 within the threshold). If the local minimum has not been reached, then the neural network has not been adequately trained, and control returns to block 1208 with a new training set. The training sequence continues until, in block 1224, a local minimum has been reached.

Now that a local minimum has been reached and the corrections have been back-propagated, in block 1232, the neural network is ready.

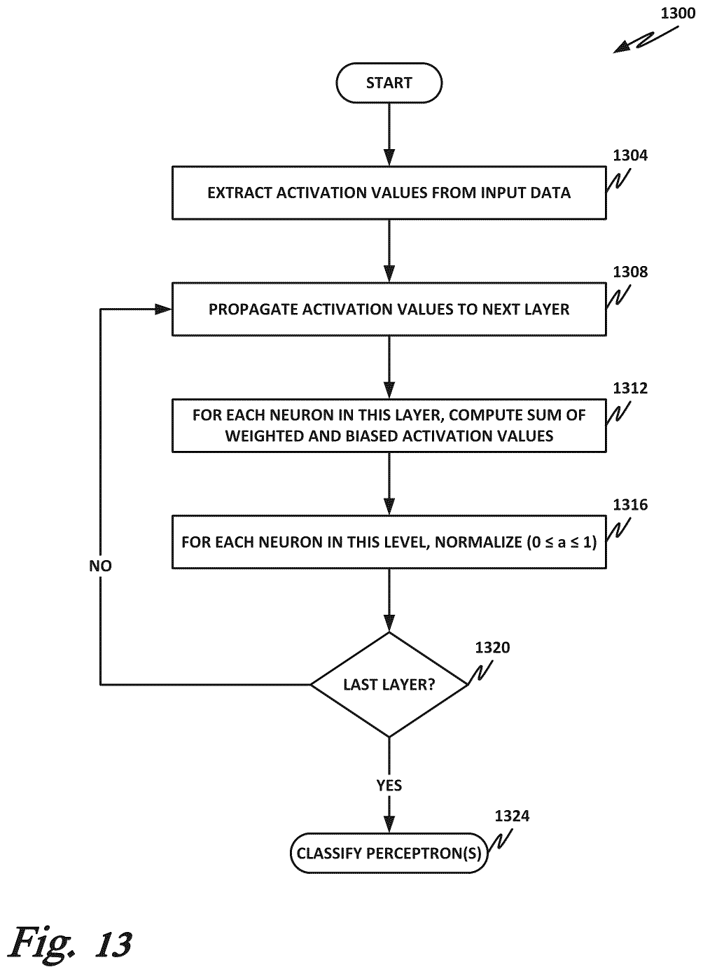

FIG. 13 is a flowchart of a method 1300. Method 1300 illustrates a method of using a neural network, such as network 1100 of FIG. 11, to classify an object.

In block 1304, the network extracts the activation values from the input data. For example, in the example of FIG. 11, each pixel in input image 1104 is assigned as an activation value to a neuron 1108 in input layer 1112.

In block 1308, the network propagates the activation values from the current layer to the next layer in the neural network. For example, after activation values have been extracted from the input image, those values may be propagated to the first hidden layer of the network.

In block 1312, for each neuron in the current layer, the neuron computes a sum of weighted and biased activation values received from each neuron in the previous layer. For example, in the illustration of FIG. 11, neuron 0 of the first hidden layer is connected to each neuron in input layer 1112. A sum of weighted values is computed from those activation values, and a bias is applied.

In block 1316, for each neuron in the current layer, the network normalizes the activation values by applying a function such as sigmoid, ReLU, or some other function.

In decision block 1320, the network determines whether it has reached the last layer in the network. If this is not the last layer, then control passes back to block 1308, where the activation values in this layer are propagated to the next layer.

Returning to decision block 1320, If the network is at the last layer, then the neurons in this layer are perceptrons that provide final output values for the object. In terminal 1324, the perceptrons are classified and used as output values.

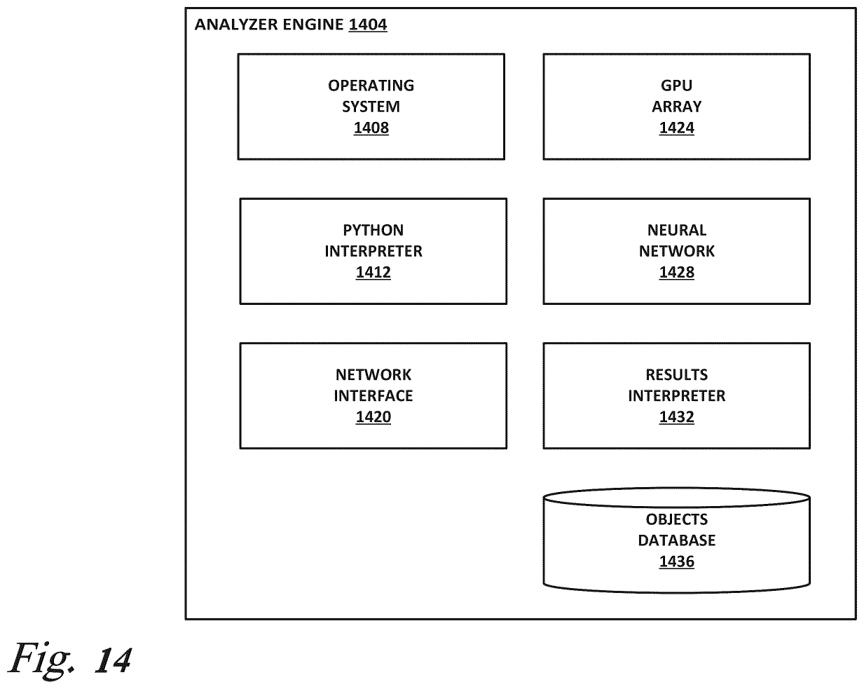

FIG. 14 is a block diagram illustrating selected elements of an analyzer engine 1404. Analyzer engine 1404 may be configured to provide analysis services, such as via a neural network. FIG. 14 illustrates a platform for providing analysis services. Analysis, such as neural analysis and other machine learning models, may be used in some embodiments to provide one or more features of the present disclosure.

Note that analyzer engine 1404 is illustrated here as a single modular object, but in some cases, different aspects of analyzer engine 1404 could be provided by separate hardware, or by separate guests (e.g., VMs or containers) on a hardware system.

Analyzer engine 1404 includes an operating system 1408. Commonly, operating system 1408 is a Linux operating system, although other operating systems, such as Microsoft Windows, Mac OS X, UNIX, or similar could be used. Analyzer engine 1404 also includes a Python interpreter 1412, which can be used to run Python programs. A Python module known as Numerical Python (NumPy) is often used for neural network analysis. Although this is a popular choice, other non-Python or non-NumPy systems could also be used. For example, the neural network could be implemented in Matrix Laboratory (MATLAB), C, C++, Fortran, R, or some other compiled or interpreted computer language.

GPU array 1424 may include an array of graphics processing units that may be used to carry out the neural network functions of neural network 1428. Note that GPU arrays are a popular choice for this kind of processing, but neural networks can also be implemented in CPUs, or in ASICs or FPGAs that are specially designed to implement the neural network.

Neural network 1428 includes the actual code for carrying out the neural network, and as mentioned above, is commonly programmed in Python.

Results interpreter 1432 may include logic separate from the neural network functions that can be used to operate on the outputs of the neural network to assign the object for particular classification, perform additional analysis, and/or provide a recommended remedial action.

Objects database 1436 may include a database of known malware objects and their classifications. Neural network 1428 may initially be trained on objects within objects database 1436, and as new objects are identified, objects database 1436 may be updated with the results of additional neural network analysis.

Once final results have been obtained, the results may be sent to an appropriate destination via network interface 1420.

The foregoing outlines features of several embodiments so that those skilled in the art may better understand various aspects of the present disclosure. The foregoing detailed description sets forth examples of apparatuses, methods, and systems relating to a system for cluster-based ML model validation in accordance with one or more embodiments of the present disclosure. Features such as structure(s), function(s), and/or characteristic(s), for example, are described with reference to one embodiment as a matter of convenience; various embodiments may be implemented with any suitable one or more of the described features.

As used throughout this specification, the phrase “an embodiment” is intended to refer to one or more embodiments. Furthermore, different uses of the phrase “an embodiment” may refer to different embodiments. The phrases “in another embodiment” or “in a different embodiment” refer to am embodiment different from the one previously described, or the same embodiment with additional features. For example, “in an embodiment, features may be present. In another embodiment, additional features may be present.” The foregoing example could first refer to an embodiment with features A, B, and C, while the second could refer to an embodiment with features A, B, C, and D, with features, A, B, and D, with features, D, E, and F, or any other variation.

In the foregoing description, various aspects of the illustrative implementations may be described using terms commonly employed by those skilled in the art to convey the substance of their work to others skilled in the art. It will be apparent to those skilled in the art that the embodiments disclosed herein may be practiced with only some of the described aspects. For purposes of explanation, specific numbers, materials, and configurations are set forth to provide a thorough understanding of the illustrative implementations. In some cases, the embodiments disclosed may be practiced without the specific details. In other instances, well-known features are omitted or simplified so as not to obscure the illustrated embodiments.

For the purposes of the present disclosure and the appended claims, the article “a” refers to one or more of an item. The phrase “A or B” is intended to encompass the “inclusive or,” e.g., A, B, or (A and B). “A and/or B” means A, B, or (A and B). For the purposes of the present disclosure, the phrase “A, B, and/or C” means A, B, C, (A and B), (A and C), (B and C), or (A, B, and C).

The embodiments disclosed can readily be used as the basis for designing or modifying other processes and structures to carry out the teachings of the present specification. Any equivalent constructions to those disclosed do not depart from the spirit and scope of the present disclosure. Design considerations may result in substitute arrangements, design choices, device possibilities, hardware configurations, software implementations, and equipment options.

As used throughout this specification, a “memory” is expressly intended to include both a volatile memory and a nonvolatile memory. Thus, for example, an “engine” as described above could include instructions encoded within a volatile or nonvolatile memory that, when executed, instruct a processor to perform the operations of any of the methods or procedures disclosed herein. It is expressly intended that this configuration reads on a computing apparatus “sitting on a shelf” in a non-operational state. For example, in this example, the “memory” could include one or more tangible, nontransitory computer-readable storage media that contain stored instructions. These instructions, in conjunction with the hardware platform (including a processor) on which they are stored may constitute a computing apparatus.

In other embodiments, a computing apparatus may also read on an operating device. For example, in this configuration, the “memory” could include a volatile or run-time memory (e.g., RAM), where instructions have already been loaded. These instructions, when fetched by the processor and executed, may provide methods or procedures as described herein.

In yet another embodiment, there may be one or more tangible, nontransitory computer-readable storage media having stored thereon executable instructions that, when executed, cause a hardware platform or other computing system, to carry out a method or procedure. For example, the instructions could be executable object code, including software instructions executable by a processor. The one or more tangible, nontransitory computer-readable storage media could include, by way of illustrative and nonlimiting example, a magnetic media (e.g., hard drive), a flash memory, a ROM, optical media (e.g., CD, DVD, Blu-Ray), nonvolatile random access memory (NVRAM), nonvolatile memory (NVM) (e.g., Intel 3D Xpoint), or other nontransitory memory.

There are also provided herein certain methods, illustrated for example in flow charts and/or signal flow diagrams. The order or operations disclosed in these methods discloses one illustrative ordering that may be used in some embodiments, but this ordering is no intended to be restrictive, unless expressly stated otherwise. In other embodiments, the operations may be carried out in other logical orders. In general, one operation should be deemed to necessarily precede another only if the first operation provides a result required for the second operation to execute. Furthermore, the sequence of operations itself should be understood to be a nonlimiting example. In appropriate embodiments, some operations may be omitted as unnecessary or undesirable. In the same or in different embodiments, other operations not shown may be included in the method to provide additional results.

In certain embodiments, some of the components illustrated herein may be omitted or consolidated. In a general sense, the arrangements depicted in the FIGURES may be more logical in their representations, whereas a physical architecture may include various permutations, combinations, and/or hybrids of these elements.

With the numerous examples provided herein, interaction may be described in terms of two, three, four, or more electrical components. These descriptions are provided for purposes of clarity and example only. Any of the illustrated components, modules, and elements of the FIGURES may be combined in various configurations, all of which fall within the scope of this specification.

In certain cases, it may be easier to describe one or more functionalities by disclosing only selected element. Such elements are selected to illustrate specific information to facilitate the description. The inclusion of an element in the FIGURES is not intended to imply that the element must appear in the disclosure, as claimed, and the exclusion of certain elements from the FIGURES is not intended to imply that the element is to be excluded from the disclosure as claimed. Similarly, any methods or flows illustrated herein are provided by way of illustration only. Inclusion or exclusion of operations in such methods or flows should be understood the same as inclusion or exclusion of other elements as described in this paragraph. Where operations are illustrated in a particular order, the order is a nonlimiting example only. Unless expressly specified, the order of operations may be altered to suit a particular embodiment.

Other changes, substitutions, variations, alterations, and modifications will be apparent to those skilled in the art. All such changes, substitutions, variations, alterations, and modifications fall within the scope of this specification.

To aid the United States Patent and Trademark Office (USPTO) and, any readers of any patent or publication flowing from this specification, the Applicant: (a) does not intend any of the appended claims to invoke paragraph (f) of 35 U.S.C. section 112, or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

What is claimed is:

1. A computer-implemented method of validating a machine learning (ML) model, wherein the ML model is a binary classifier, the method comprising:
training the ML model on a training set comprising labeled objects from a first class and a second class, to provide a trained ML model; and
validating the ML model on a training set, wherein the training set comprises at least some unlabeled objects, and for unlabeled objects, using an estimated classification as a proxy for a known label, wherein the estimated classification is based on computing a smallest distance to respective known feature vector clusters for the first and second classes.

2. The method of claim 1, wherein the binary classifier is a malware classifier, and wherein the first class is a clean class the second class is a malware class.

3. The method of claim 1, further comprising assigning a confidence to the estimated classification.

4. The method of claim 3, wherein the confidence comprises an absolute difference between a distance to a nearest feature vector cluster for the first class and a distance to a nearest feature vector cluster for the second class.

5. The method of claim 3, further comprising assigning the unlabeled objects to confidence buckets based on the respective confidences of the unlabeled objects.

6. The method of claim 5, further comprising computing error bars for the confidence buckets.

7. The method of claim 6, further comprising identifying an outlier cluster of feature vectors outside of the error bars, and designating the outlier cluster for additional analysis.

8. The method of claim 5, further comprising aggregating counts of the first class and second class by confidence bucket.

9. The method of claim 8, further comprising calculating an error for the confidence bucket using an average prediction score and total count of feature vectors.

10. The method of claim 1, further comprising computing the respective known feature vector clusters.

11. The method of claim 10, wherein computing the known feature vector clusters comprises receiving a set of feature vectors for known objects, including objects of the first class and objects of the second class, and computing for respective known feature vectors a smallest minimum distance to a cluster core.

12. The method of claim 11, wherein computing the smallest minimum distance comprises generating a distance score array, calculating a sum of closest distances for individual feature vectors, and adding the sum to the distance score array.

13. The method of claim 12, wherein generating the distance score array comprises creating a zeroed array of distances with indexes matching an array of feature vectors, and for each of a set of input feature vectors, computing a distance between the input feature vector and an iterated feature vector.

14. The method of claim 1, wherein computing the smallest distance to respective known feature vector clusters comprises computing a first distance to a nearest cluster core of the first class and second distance to a nearest cluster core of the second class, and selecting an estimated class based on a lesser of the first distance or the second distance.

15. The method of any of claim 1, further comprising computing a model score for the ML model as disproportional to a ratio of total error amount to total number of model classifications.

16. The method of claim 15, further comprising plotting a model validation for the model, and presenting the plotted model validation to a human user.

17. One or more tangible, nontransitory computer-readable media having stored thereon machine-executable instructions to validate a trained machine learning (ML) model, wherein the ML model is a binary classifier, and wherein validating the ML model comprises:
receiving a training set, the training set comprising objects including both labeled objects and unlabeled objects;
operating the ML model to classify the objects of the training set as belonging to a first class or a second class according to computed classifications;
for labeled objects of the training set, comparing the computed classification to known classes of the labeled objects, and
for unlabeled objects, comparing the computed classifications to estimated labels, comprising estimating labels for at least some of the unlabeled objects, wherein estimating labels comprises extracting a feature vector for an object, and calculating a distance from the extracted feature vector to feature vector clusters for the first class and second class.

18. The one or more tangible, nontransitory computer-readable media of claim 17, wherein the binary classifier is a malware classifier, and wherein the first class is a clean class the second class is a malware class.

19. A computing apparatus, comprising:
a processor circuit and a memory; and
instructions encoded within the memory to instruct the processor circuit to validate a trained machine learning (ML) model, wherein the ML model is a binary classifier to classify objects into a first class and a second class, and wherein validating the ML model comprises:
receiving a training set, the training set including both labeled objects and unlabeled objects;
operating the ML model to classify objects of the training set and provide computed classes for the objects;
for labeled objects, comparing the computed classes to known class of the labeled objects;
for unlabeled objects, providing estimated labels, comprising extracting a feature vector for an object, calculating a distance from the extracted feature vector to feature vector clusters for the first class and second class;
and comparing the computed classes to the estimated labels.

20. The computing apparatus of claim 19, wherein the binary classifier is a malware classifier, and wherein the first class is a clean class the second class is a malware class.
